(19) United States
(12) Patent Application Publication
(10) Pub. No.: US 2010/0287087 A1
(43) Pub. Date: Nov. 11, 2010

(54) APPARATUS AND METHODS FOR EXCHANGING PRODUCTS AT CALCULATED RATE

(76) Inventors: Peter Bartko, New York, NY (US); John Capuano, New York, NY (US); Sven Mika, New York, NY (US); Thomas D. Bradshaw, New York, NY (US)

Correspondence Address: INNOVATION DIVISION, CANTOR FITZGERALD, L.P., 110 EAST 59TH STREET (6TH FLOOR), NEW YORK, NY, 10022, US

(21) Appl. No.: 12/464,099

(22) Filed: May 11, 2009

(51) Int. Cl. G06Q 40/00

(52) U.S. Cl. 705/37

(57) ABSTRACT

Methods and systems are provided herewith for determining prices and executing trades among a plurality of users of an electronic trading system. The users may transmit to a processor a plurality of bid-offer pairs. Each bid-offer pair may comprise an estimate of a fair bid price and an estimate of a fair offer price for exchanging between a first and a second currency. The processor may determine from the bid-offer pairs a qualifying set of overlapping bid-offer pairs. The processor may determine an exchange rate for exchanging between the first currency and the second currency based on the qualifying set of overlapping bid-offer pairs. The processor may match user orders to exchange between the first and second currencies and execute those orders at the exchange rate.

### BRIEF DESCRIPTION OF THE FIGURES

FIG. 1 depicts a system according to at least one embodiment of the systems disclosed herein;

FIG. 2 depicts a system according to at least one embodiment of the systems disclosed herein;

FIG. 3 depicts a flow diagram according to at least one embodiment of the methods disclosed herein;

FIGS. 4-5 depict exemplary bid-offer pairs according to at least one embodiment of the methods disclosed herein;

FIGS. 6-7 depict an exemplary graph showing changes in a market price over time according to at least one embodiment of the methods disclosed herein;

FIGS. 8 and 9 depict exemplary tables showing trading information that may be determined according to at least one embodiment of the methods disclosed herein;

FIGS. 10-13 depict exemplary graphs showing trading information that may be determined according to at least one embodiment of the methods disclosed herein; and

FIGS. 14-25 depict exemplary interfaces for managing and communicating order information according to at least one embodiment of the invention.

### DETAILED DESCRIPTION

The following sections I-XI provide a guide to interpreting the present application.

I. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

III. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, article or other product is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device, article or other product is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

IV. Disclosed Examples and Terminology are not Limiting

Neither the Title (set forth at the beginning of the first page of the present application) nor the Abstract (set forth at the end of the present application) is to be taken as limiting in any way as the scope of the disclosed invention(s), is to be used in interpreting the meaning of any claim or is to be used in limiting the scope of any claim. An Abstract has been included in this application merely because an Abstract is required under 37 C.F.R. §1.72(b).

The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The preambles of the claims that follow recite purposes, benefits and possible uses of the claimed invention only and do not limit the claimed invention.

The present disclosure is not a literal description of all embodiments of the invention(s). Also, the present disclosure is not a listing of features of the invention(s) which must be present in all embodiments.

All disclosed embodiment are not necessarily covered by the claims (even including all pending, amended, issued and canceled claims). In addition, an embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

V. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

A “processor” means one or more of the following: microprocessors, central processing units (CPUs), computing devices, microcontrollers, digital signal processors, or like devices or any combination thereof, regardless of the architecture (e.g., chip-level multiprocessing/multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

VI. Continuing Applications

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

Applicants intend to file additional applications to pursue patents for subject matter that has been disclosed and enabled but not claimed in the present application.

VII. 35 U.S.C. §112, Paragraph 6

In a claim, a limitation of the claim which includes the phrase “means for” or the phrase “step for” means that 35 U.S.C. §112, paragraph 6, applies to that limitation.

In a claim, a limitation of the claim which does not include the phrase “means for” or the phrase “step for” means that 35 U.S.C. §112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. §112, paragraph 6, applies to that step(s).

With respect to a means or a step for performing a specified function in accordance with 35 U.S.C. §112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. §112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Where there is recited a means for performing a function that is a method, one structure for performing this method includes a computing device (e.g., a general purpose computer) that is programmed and/or configured with appropriate hardware to perform that function.

Also included is a computing device (e.g., a general purpose computer) that is programmed and/or configured with appropriate hardware to perform that function via other algorithms as would be understood by one of ordinary skill in the art.

VIII. Disclaimer

Numerous references to a particular embodiment do not indicate a disclaimer or disavowal of additional, different embodiments, and similarly references to the description of embodiments which all include a particular feature do not indicate a disclaimer or disavowal of embodiments which do not include that particular feature. A clear disclaimer or disavowal in the present application shall be prefaced by the phrase “does not include” or by the phrase “cannot perform”.

IX. Incorporation by Reference

Any patent, patent application or other document referred to herein is incorporated by reference into this patent application as part of the present disclosure, but only for purposes of written description and enablement in accordance with 35 U.S.C. §112, paragraph 1, and should in no way be used to limit, define, or otherwise construe any term of the present application, unless without such incorporation by reference, no ordinary meaning would have been ascertainable by a person of ordinary skill in the art. Such person of ordinary skill in the art need not have been in any way limited by any embodiments provided in the reference

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

X. Prosecution History

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

XI. Other Definitions

An “exchange rate” for exchanging the currency of one country for currency of another is the ratio at which the unit of currency of one country is or may be exchanged for the unit of currency of another country.

As used herein, two price ranges “overlap” if the two ranges cover at least one price (including fractional prices such as $10.25000001) in common.

As used herein, a “bid-offer pair” is a bid and an offer for the same product (e.g., a bid and offer to exchange one currency for another) that is associated with a single party or entity and is also associated with a specific time or duration. For example, a “bid-offer pair” may comprise a bid to buy 1 Euro for $1.50 and an offer to sell 1 Euro for $2.00, in which the bid and offer are received from Bank ABC at the same time.

Although various embodiments are described with respect to the exchange of currencies (e.g., foreign currencies), it should be understood by those of ordinary skill in the art that the system may be used for any product or service.

### Detailed Description of Exemplary Embodiments

According to various embodiments of the invention, an apparatus comprising at least one processor and a memory may be configured to determine a market price and execute a trade between users. The memory may stores instructions which, when executed by the at least one processor, directs the at least one processor to perform various actions. A plurality of users of an electronic trading system may transmit a corresponding plurality of bid-offer pairs to the at least one processor. The plurality of users may comprise a first user and a second user. Each bid-offer pair may comprise (1) a bid price comprising an estimate of a fair bid price for purchasing a first currency in units of a second currency and (2) an offer price comprising an estimate of a fair offer price for selling the first currency in units of the second currency. The bid-offer pair may define (a) a range of prices between the offer price and the bid price and (b) a quote spread comprising the difference between the bid price and the offer price. The at least one processor may determine from the plurality of bid-offer pairs a set of overlapping bid-offer pairs. Determining a set of overlapping bid-offer pairs may comprise several actions. First, the at least one processor may determine that the bid price and the offer price of each bid-offer pair in the set of overlapping bid-offer pairs is unexpired during the time of interest. The at least one processor may determine whether any of the bid-offer pairs comprises a bid price that is lower than the offer price of the bid-offer pair. For each bid-offer pair, the at least one processor may determine that the bid-offer pair comprises a quote spread that is less than a predetermined threshold. Finally, the at least one processor may determine from the plurality of bid-offer pairs a set of qualifying bid-offer pairs. The set of qualifying bid-offer pairs may comprise each bid-offer pair of the plurality of bid-offer pairs that satisfies the following conditions. (a) The bid price of the bid-offer pair and the offer price of the bid-offer pair are both unexpired at the time of interest. (b) The bid price of the bid-offer pair is lower than the offer price of the bid-offer pair. (c) The bid-offer pair comprises a quote spread that is less than a predetermined threshold. The at least one processor may determine from the set of qualifying bid-offer pairs a set of overlapping bid-offer pairs. Each overlapping bid-offer pair may comprise a range such that (i) the number of bid-offer pairs having a range that overlaps the range of the bid-offer pair is at least half of (ii) the number of eligible bid-offer pairs minus one. Two ranges “overlap” if they both include at least one price in common. The at least one processor may determine an exchange rate for converting the first currency into the second currency based on the set of overlapping bid-offer pairs, in which the act of determining the exchange rate comprises calculating an average of the bids and offers in the set of overlapping bid-offer pairs. The exchange rate is equal to the average of the bids and offers in the set of overlapping bid-offer pairs. The at least one processor may receive from the first user a first order to purchase the first currency in exchange for the second currency. The at least one processor may receive from the second user a second order to sell the first currency in exchange for the second currency. The order to purchase and the order to sell are unexpired during the time of interest. The at least one processor may match the first order and the second order. The at least one processor may also execute a trade between the first user and the second user based on the act of matching. The at least one processor may transmit a confirmation of the executed trade to the first user and the second user.

After a plurality of transactions on the exchange, n some embodiments the system may determine and output price flow information. The information may indicate information about a change in the price of products purchased or sold on the exchange, e.g., between two parties. The price flow information may be transmitted to one or more parties, such as the two parties. In some embodiments, the information may be used to provide information about an adjustment in a market price between two users so that aggregate flow between the parties is close to zero over time. For instance, if one user yielded high positive flow against another party during one day, the system may output the graphs and indicate a recommended adjustment in the market price for transactions between the parties in a second day. For example, the recommended adjustment may be an adjustment that, assuming a consistent volume of transactions between the two parties in the second day (and neutral net price flow), the price flow of all transactions between the two days would be close to zero. Thus, if the first user yielded a price flow of positive 0.01 basis points in the first day against a second party, the market price between the two parties may be adjusted in favor of the second party by 0.01 basis points for all transactions between the parties in the second day. (For example, the market price could be adjusted so that the second party buys from the first party at 0.01 basis points below the market price and sells to the first party at 0.01 basis points above the market price.)

In some embodiments, parties may wish to have substantially zero net flow between them over time so that neither has an advantage over the other in the long run. Such a system may encourage users to participate in the system, since the rules of the system may prohibit one party from yielding substantial market gains over another. In some embodiments, users may wish to participate in the system to buy and sell products (such as commodities or currencies) not to make a profit on those products directly, but to hedge a large short or long position in those products, e.g., in another market.

In some embodiments, the system may enable users such as banks to transfer risk, in size, largely out of sight of the market. In some embodiments, liquidity may be self-sustaining. In some embodiments, users such as banks may trade currencies on an exchange with anonymity and price transparency. In some embodiments, users of an exchange for a particular market (such as a currency exchange market) may be limited to commercial banks and investment banks. In some embodiments, trading is enabled on a name give-up basis only. In some embodiments, the system may disallow participation by a prime brokerage and may disallow agency trading.

In some embodiments, the system may round decimalized pricing to avoid spread compression. Mid-point matching of crossed bids and offers so counterparties share price improvements. In some embodiments, the system may specify a minimum initial order size of 2 million base currency.

In some embodiments, the systems and methods described herein may be implemented for a plurality of users of a trading system. In some embodiments, the users may comprise one or more banks, such as commercial banks. In some embodiments, the users may be limited to a group of banks, such as a particular type of commercial bank, e.g., commercial banks having an eCommerce automated hedging system.

In some embodiments, certain types of users may be restricted from participating in the system. In some embodiments, one or more of the following groups or types of users may be prohibited from using the system described herein: aggregators (e.g., aggregator traders), prop trading systems, high frequency trading systems, individual traders (i.e., traders representing a single individual's account or a personal user trading account).

In some embodiments, banks may expose risk to trade at running mid-point with minimum danger. In some embodiments, various features of the system may encourage against gaming the trading system to achieve price advantages.

In some embodiments, market data may not be distributed to users. For example, the system may not communicate to users the actual price at which a user's order will trade (e.g., the price may not be output at a user display device). For example, the current price (e.g., the midpoint or adjusted midpoint) may be hidden from all users.

In some embodiments, the system may calculate a price defining a mid-point. The system may continually (or continuously) or periodically update the midpoint price. Accordingly, the system may calculate a running midpoint price. In some embodiment, the midpoint price (or adjusted midpoint price) may be the only tradable rate in the order book.

In some embodiments, one or more users (e.g., all users or all or a subset of those users eligible to trade in a particular market, such as a market having a “dark pool”) may provide one or more prices to the system. In some embodiments, the prices may comprise market-neutral, non-tradable rate feed comprising one or more prices, such as a bid-offer pair comprising a bid price and an offer price in one currency for one or more financial products such as another currency.

In some embodiments, the system may determine a midpoint price for one product based on the information provided by the users. For example, in some embodiments the system may determine a midpoint based on one or more prices provided by one or more users.

In some embodiments, the system may average one or more quotes (e.g., all quotes or all qualified quotes) from rate feeds to set mid-point. The system may determine a midpoint a variety of different ways.

In some embodiments, prices may be determined to a configured degree of accuracy. For example, quotes from users and midpoints may be determined and communicated to a predetermined level of precision, such as to the nearest 0.01, 0.001, 0.0001, 0.00001, 0.000001, or 0.0000001 units of a specific currency. In some embodiments, prices may be provided or determined to the nearest whole pip. For example, in some embodiments, a midpoint price and/or an adjusted midpoint price may be determined to six decimal prices. In some embodiments, quotes from users may be received in whole pip increments, and a midpoint may be calculated to a fifth or sixth decimal point.

In some embodiments, the system may execute an electronic trading system.

The system may receive orders from users, such as bids and offers. The system may match bids for one type of product against offers for the same product (and vice versa) at the determined mid-point rate at the time of match. In some embodiments, the trading system may use features of known trading systems such as those described or referenced herein. Bids and offers may be submitted to the system at one or more different times, such as any time desired by the user or at specific times designated by the system (e.g., every hour on the hour).

In some embodiments, the system may enable the purchasing and selling of one or more products or services, such as financial products. Financial products may comprise one or more stocks, bonds, currencies, commodities, futures, options, and other derivatives and financial products. For example, the system may enable users to exchange one or more amounts of one currency in exchange for one or more amounts of another currency, e.g., at an exchange rate.

In some embodiments, the system may accept orders for a product that specify a size but not a price or rate. (For example, the system may ignore a price/rate if one is provided.)

In some embodiments, the system may require a minimum duration of an order, such as one second, two seconds, five seconds, thirty seconds, one minute, two minutes, five minutes, fifteen minutes, half hour, an hour, etc. In some embodiments, a relatively long minimum duration may discourage users from submitting orders on the system's trading system as well as other venues. In some embodiments, the system may require a minimum size (e.g., volume) for an order. (E.g., the system may reject any order below a predetermined size, or the system may be configured so that only orders above a certain size may be entered or submitted to the system.) For instance, a minimum order size may be 1/32 of one unit, ½ of one unit, one unit, 500, one thousand, one million, two million, five million, ten million, of another number of units (e.g., of a product such as a financial product, e.g., a currency). In some embodiments, different products may have different minimum order sizes (e.g., one million dollars in a dollar/euro exchange, and ten million pesos in a peso/dollar exchange).

In some embodiments, users may know the identify of all users eligible to trade in a particular market (e.g., a market for foreign currency). In some embodiments, the system may not disclose which user submitted a particular order. In other words, the identify of the user who submitted an order may remain hidden.

In some embodiments, users comprise one or more commercial banks that communicate quotes and orders directly to system, e.g., without an intermediary such as a broker or agent.

In some embodiments, changes required at banks may include orders without price (TS ignores price if submitted) and how to handle minimum time duration of orders.

In some embodiments, the system may require a user to have two different user ids.

In some embodiments, the system may require a 1st dedicated user id for non-tradable market-neutral rate feeds (in whole pip spreads).

In some embodiments, the system may require a 2nd Dedicated user id for submitting orders.

In some embodiments, the system may impose a default setting that an order user id cannot trade with itself.

In some embodiments, the matching engine may cancel indicative rates after time-to-life expiry (configurable currently 2 seconds) to mitigate stale rate in calculation of running mid-point.

In some embodiments, If rate feed refreshes only one side of a spread, the trading system may automatically extends life of the non-refreshed bid or offer for TTL (time-to-life, e.g., time to expiry).

In some embodiments, trading system continues calculating mid-point with remaining feed(s).

In some embodiments, If all rate feeds disconnect trading system cancels all orders immediately, regardless of TTL and rejects new orders.

In some embodiments, When individual order feed disconnects, trading system cancels all orders immediately from that user, regardless of TTL.

In some embodiments, the system may not allow trade setting.

In some embodiments, users (e.g., Banks) may agree to share data, such as market data.

In some embodiments, a fair market price (e.g., a running midpoint market price) may be calculated as follows. When calculating running mid-point,

Rule 1: Reject all inverted quotes

Rule 2: Reject all quotes with wide spreads (configurable by currency pair by counterparty)

Rule 3: After applying rules 1 & 2, to calculate mid-point, average together only remaining quotes from banks that overlap with 50% or more of other remaining quotes.

For bank 1 to overlap with bank 2, the bid of bank 1 must be less than or equal to the offer of bank 2 and the offer of bank 1 must be greater than or equal to the bid of bank 2.

For each bank, count the number of other banks with which its quotes overlaps and calculate the percentage (%) of overlapping banks÷all remaining banks. (The bank itself is not included in calculating the percentage. If there are 4 banks, and bank 1 overlaps with banks 2 and 3, but not with bank 4, the percentage is 66.6%; 2÷3.)

To calculate the midpoint, average together only the quotes from banks which overlap with 50% or more of remaining banks.

If there are no banks with overlapping quotes with 50% of remaining banks, then no midpoint. (example 2 banks with no overlap, 4 banks with 2 each only overlapping, bank 1 overlaps bank 2 only, bank 3 overlaps bank 4 only. 1÷3=33%. Each % is 33% which is <50%).

In some embodiments, Eliminate rule to drop low bid and high offer quotes when more than 5 rate feeds.

In some embodiments, one-sided prices may be rejected.

In some embodiments, Banks' ecommerce businesses may regularly measure the quality of the flow of transactions with each of their counterparties. If they determine that a counterparty's flow is consistently unprofitable, they may then choose to take corrective action such as widening spreads quoted or not dealing for example.

How banks calculate flow counterparty profitability: In some embodiments, banks may take a sample of several hundred to thousands of transactions, and then revalue each transaction at the market mid-point rate at regular intervals subsequent to the trade of 500 ms, 1 sec, 2 sec, 5 sec, 10 sec, 30 sec, 45 sec, 60 sec, 2 min. They then produce a flow graph that shows the subsequent average profitability of those trades (with an indication of the standard deviation). They expect the graph to be relatively flat (within reasonable error boundaries). If the graph shows a considerable negative effect (−0.2 to −0.5 pips for example), this is considered to be “bad flow”.

In some embodiments, the trading system may facilitate the exchange of countervailing risk at a fair price (market neutral midpoint). In some embodiments, participant banks may expect flow from transactions effected on MIDFX with other participants to be neutral (flat curve).

In some embodiments, Risk occurs in banks as a consequence of trading with many different counterparties through many different channels, some “good”, some “bad”. In some embodiments, To ensure orders delivered to MIDFX will result in “good flow”, banks have to filter out the “bad”. This requires work and use of scarce resources.

In some embodiments, banks may have a willingness to trade with “bad flow” counterparties if the rate at which transactions are matched is adjusted to offset the potential losses. If the adjustor is the counterparty suffering the loss and the adjustee is the counterparty taking the profit, then all adjustor's buys from the adjustee will be executed at the midpoint minus (−) the adjustment amount and all adjustor's sells to the adjustee will be executed at the midpoint plus (+) the adjustment amount.

In some embodiments, flow curves may be generated by counterparty pair. In some embodiments, the system may calculate the rate adjustment required to correct each curve to neutral.

In some embodiments, participants may be enabled to agree amount and duration of adjustment to be applied.

In some embodiments, instructions may be transmitted to the Trading System, e.g., by one or more users.

In some embodiments, the trading system may execute the instruction and deliver both midpoint and execution rate to one or more users.

In some embodiments, the system may generate flow curves and calculate adjustment: at specified configurable intervals (every: day, week, x hours for example); for specified counterparty; for a specified configurable number of transactions (last 100, 500, 1000 trades, etc or all trades from specified start time or for time period from xx:xx hours to yy:yy hours, for example); for specified counterparty (including all); for all transactions taken together and for each currency pair.

In some embodiments, the system may calculate the adjustment to the executed midpoint required to flatten overall curve to neutral and adjustment to each currency pair that taken together would bring overall curve to neutral. In some embodiments, the system may show statistical error bands for which no adjustment is necessary (±0.000005 for example). In some embodiments, the Mid-point and adjustment may be calculated to 6 decimals (configurable), e.g., with some exceptions. In some embodiments, the system may specify the elapsed time the adjustment should be in place.

For example, the system may specify an adjustment such that when BANK A buys from BANK B (or Bank B sells to Bank A), the market rate is increased by (+) 0.000016. And when BANK A sells to BANK B (or BANK B buys from BANK A), the rate is decreased to (−) 0.000016. This may be effective for a specified time, e.g., FROM: dd mm yyyy hh:mm:00 TO: dd mm yyyy hh:mm:00.

In some embodiments, the system may enable counterparties to view flow graphs and agree midpoint rate adjustment.

In some embodiments, the Methods to show flow graphs and calculated mid-point adjustment to counterparties may include any method of communication disclosed herein, such as email, a secure web site (MIDFX credit web app site for example).

In some embodiments, the system may enable users to configure a rate adjustment at a website or over email. Similarly, the system may enable users via email or on web site to show agreement to rate adjustment.

In some embodiments, users may provide mid-point rate adjustment data to trading system.

In some embodiments, Rate adjustment may be entered manually or automatically (e.g., by the system).

In some embodiments, confirmation of trade to each counterparty must include both rate at which trade executed and the then current midpoint.

In some embodiments, to ensure banks are meeting mutual expectations of behavior, they may agree to share data of their activity on the trading system.

In some embodiments, the system may occasionally distribute to users data regarding non-tradable rate feeds used to calculate the running mid-point. In some embodiments, the system may distribute to users order data and a volume graph. In some embodiments, the system provides such information over a restricted access web site.

In some embodiments, the system may generate hourly reports via email. In some embodiments, the system may receive streaming non-tradeable rates from 10 banks. The system may remove extremes to calculate average midpoint. In some embodiments, the system may filter out hedging requirements from toxic counterparties so that these do not affect the midpoint calculation.

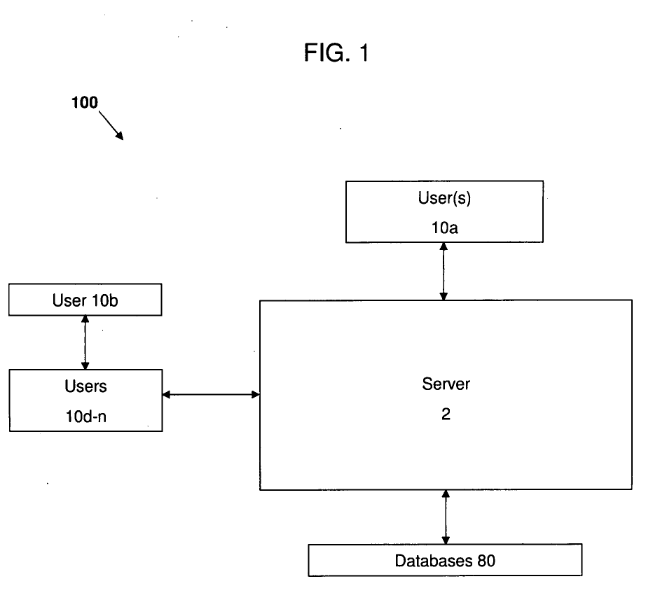

FIG. 1. Exemplary System for Determining a Market Price

Some embodiments of the present invention provide systems and methods for determining a market price.

Server 2 may comprise one or more processors, computers, computer systems, computer networks, and or computer databases. Server 2 may comprise modules 18-64. Server 2 may also comprise one or more databases, such as databases 80. Server 2 may communicate with users 10. For instance, server 2 may communicate with a user 10 computer, such as a browser of a user computer, e.g., over the internet.

Modules of server may comprise one or more processors, computers, computer systems, and/or computer networks.

Databases 80 may comprise one or more processors, computers, computer systems, computer networks, and/or computer databases configured to store information. Each of databases 80 may communicate with server 2 and modules. For instance, server 2 and modules may store information in databases 80 and may also use information stored in databases 80.

FIG. 1 depicts a system 100 for determining a market price.

The system 100 may comprise one or more servers 2 coupled to one or more databases 80, one or more data providers 8a-8n, and one or more end users 10a-10n. The data providers 8a-8n, users 10, agents 12, and server 2 may each communicate with each other. Users 10 may also communicate with other users 10, e.g., regarding one or more orders or market prices. For example, a user 10a may propose to engage in a transaction with another user 10b to buy, sell, or exchange one or more securities of user 10a. For example, the system may determine a market price of a product.

In some embodiments, the system 100 may communicate with users 10a-10e and operate as (or communicate with) an exchange so that users 10a-10e may submit orders and execute trades with other users of the exchange. For example, the system may incorporate and/or utilize the computer systems, user interfaces, and other features and functionality as disclosed in U.S. Pat. No. 6,560,580 and U.S. patent application Ser. No. 09/801,495 filed Mar. 8, 2001, Ser. No. 10/301,527 filed Nov. 21, 2002, Ser. No. 10/699,858 filed Oct. 31, 2003, Ser. No. 11/122,510 filed May 4, 2005, and Ser. No. 12/189,266 filed Aug. 11, 2008, the disclosures of which are incorporated herein by reference in their entireties.

Users 10a-10n may comprise one or more persons, companies, financial entities, representatives, or other entities. A user 10 may be associated with one or more orders. For example, user 10 may own or control one or more orders in an account associated with the user 10 in a database. As used in this application, a user 10 may also refer to a user's interface to other system 100 components (such as server 2).

For example, a user's 10 interface may comprise a user's PDA or computer, or a program running on a user's computer such as a computer web browser like Internet Explorer™, which may communicate with data providers 8 and/or server 2. A user's 10 computer may comprise one or more processors, memories, and input and output devices for communicating with other modules, databases, and other system elements. A user's 10 computer and interface may comprise functionality to select one or more orders and portfolios, and parameters (as described below). User's 10 computer may also comprise trading functionality to view and submit bids, offers, lifts, and takes. In some embodiments, user's 10 computer may comprise all the functionality of trader terminals known in the art, such as those used to trade over the New York Stock Exchange, NASDAQ, and eSpeed platforms.

The server 2 may comprise a computer, server, hub, central processor, or other entity in a network, or other processor. The server 2 may comprise input and output devices for communicating with other various system 100 elements. In some embodiments, the server 2 may be comprised in an end user's computer 10. For example, server 2 may operate as a toolbar in a user's web browser or another program running on the user's computer. In some embodiments, the server 2 may comprise a plurality of servers and/or computers.

The server 2 may comprise a plurality of modules. Each module may comprise one or more processors, memories, and input and output devices for communicating with other modules, databases, and other system elements. In some embodiments, functions described herein for a specific module may be performed by a specific module or by the server 2.

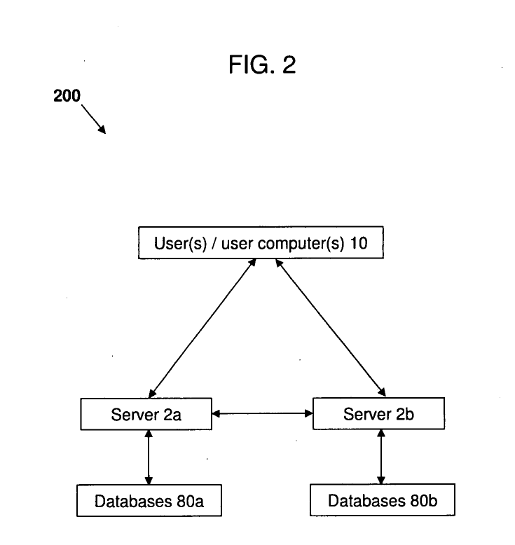

As shown in FIG. 2, server 2 may comprise two servers 2a and 2b, in which each server 2 has a corresponding database 80a and 80b.

The server may comprise various modules for accomplishing various functions described here.

For example, user interface module may communicate with users. User interface module 18 may communicate with users so that users can set up an account, log in to an account; prompt a user to submit preferences concerning one or more payments and/or orders; receive user preferences and selections concerning one or more payments and/or orders; communicate with users to provide information regarding one or more payments and/or orders; or receive any other inputs from user and output any other outputs to user, as described herein.

User interface module may cause information to be output to a user, e.g., at a user output device such as a display device (e.g., a display device at a user terminal), a speaker. The information outputted to a user may be related to a user account, one or more payments and/or orders, preferences, and other information described herein. User interface module may communicate the information electronically, e.g., via networked communication such as the internet (e.g., in an email or webpage), telecommunication service, etc.

User preferences module may receive, identify, or determine user preferences concerning one or more payments and/or orders. For instance, the module may receive the preferences from a user interacting with a user interface. The module may also receive them from an automated user terminal. The module may also determine preferences based on a program that automatically determines user preferences concerning one or more payments, orders, and/or portfolios. User preferences may include preferences that are related to, or that specify, any of the following with respect to one or more payments or orders: estimated fair price; market price; calculation of market price by the system; volume of orders (e.g., minimum and maximum orders); and any other preferences (e.g., as described herein).

User account module may create and manage a user account. In some embodiments, the user account may be a financial account such as a trading account, investment account, or other financial account. Accordingly, in some embodiments, user account module may operate similarly to an online brokerage account, such as those offered by e*Trade, Ameritrade, Schwab, etc. In some embodiments, user account module may determine information about a user's holdings based on the user's 10 order book.

Financial information module may determine financial information associated with one or more users, one or more currencies, one or more exchange rates, one or more market prices, one or more securities, one or more portfolios, one or more business enterprises (such as a company, partnership, corporation, etc.), and other financial information. The financial information may comprise any current, historical, and predicted financial information that may be relevant to the one or more users, one or more currencies, one or more exchange rates, one or more securities, one or more portfolios, and one or more business enterprises. For example, financial information may comprise current, historical, and predicted information concerning interest rates, prices of one or more entities (e.g., securities such as orders), and/or any other financial information. For instance, with respect to a financial entity such as a company (e.g., a bank) or financial instrument such as an order (e.g., an order to exchange currency), financial information may comprise past, present, or predicted information concerning any of the following: market capitalization, price, earnings, volatility, volume traded during a time period, number and type of issued securities outstanding, dividends paid, highest or lowest price in a period, percentage of institutional ownership, beta, coupon value, issuance price, purchase price, market price, prices of related derivatives (e.g., calls, puts, and futures of a order), interest rate spread against U.S. treasuries, par, maturity, payment record (extent to which an issuer has timely paid all prior schedule payments), industry data, comparable company data, exchange rate to another currency, one or more government interest rates or changes in interest rate (e.g., a cut in a Fed rate), earnings, information in a financial report by an analyst or company (such as a 10Q, 10K, 8K, or other report or analysis), company debt, company assets, total cash and reserve, predicted time or likelihood of default, volatility of stock or bond price, volatility of market (e.g., one or more market indices such as the DJIA), information based on such financial information (such as a price to earnings ratio), exchange that trades the instrument, rating of an instrument or company by an entity (such as Moody's, Fitch's, or Standard and Poor's), an index (such as a broad market index or global sovereign index), a Treasury yield curve, a renegotiation or attempt to renegotiate terms of payment for a order, an announcement that a credit rating agency is seeking to review a prior rating of an issuer, and any other financial information. Financial information may also comprise more general information relating to the market or the economy (in the past, present, or predicted future), such as consumer credit information, the consumer price index, a government (e.g., U.S. federal government) budget balance, housing starts, jobless claims, unemployment rate, and other financial information.

Price module may determine and associate one or more values or prices with one or more estimates of a fair market bid or offer or an actual order by a user. Prices may include a current price, a historical price (e.g., a price such as a market price at a prior time, such as a week earlier or an original date of issuance of a order that pays a plurality of payments), and an estimated future price. In some embodiments, price module may determine a purchase price of one or more instruments.

In some embodiments, price module may derive a price (e.g., an estimated current market price) for an order (e.g., an order to buy or sell one currency in units of another currency) using financial information, e.g., as known in the art. For instance, such a price may be derived from information such as a current market bid and/or offer price of the order on an exchange, and other financial information (e.g., a prediction about a change in an interest rate, e.g., in a particular country). In this way (and according to methods known in the art), price module may determine prices such as exchange rates.

In some embodiments, price module may allocate one or more portions of a purchase price of a order (or series of purchases over time for the same order) to a plurality of payments of the order (e.g., past, present, and future payments related to the purchase price). For example, portions of a purchase price may be allocated to payments in a similar manner or ratio as a market price may be allocated to the payments.

Parameters module may determine parameters or other criteria for one or more payments and/or orders. For instance, parameters module may determine search parameters for finding securities (e.g., orders) and/or one or more sets of payments that satisfy user preferences and/or hedge criteria. Parameters module may determine parameters based on input from a user 10 or other information. For example, parameters module may receive parameters or selections of parameter values from a user, e.g., based on prompts from the server 2. Parameters may comprise financial information (as described above) including, e.g., information about targeted payment dates, industry sectors, payment amounts, preferred issuers, preferred balance between asset classes, other desirable features of a portfolio described herein, and other financial criteria.

Exchange module may operate a trading exchange or trading system in which users 10 may buy and sell financial instruments such as orders. The trading exchange may have functionality similar to the New York Stock Exchange, the Chicago Mercantile Exchange, NASDAQ, and other exchanges known in the art. The trading exchange may comprise the eSpeed platform.

In some embodiments, exchange module may buy and sell assets in a portfolio, such as currencies. The system may do this automatically. For instance, a user may specify that the system should purchase one or more currencies. The user may specify various parameters, e.g., quantities that should be purchased at a specific time or during a specific time period (e.g., 20 million dollars in exchange for yen from noon to 1 pm).

The various modules may function separately or in various combinations. The modules may communicate with a plurality of databases, which may also function collectively or separately.

The modules of server 2 may store, access and otherwise interact with various sources of data, including external data, databases, inputs, and other sources of data.

Databases

One or more databases 80 may be coupled to the server 2. The database 80 may comprise a plurality of databases as described below. Databases 80 may store any information described herein about users, modules, financial information, market prices, and other information. For example, database 80 may store information associated with a user and a user account, such as a user name, account security information such as a password or code, and user preferences, e.g., regarding one or more parameters. For any user having a financial account, the database may store information about the user account, such as one or more orders and other securities associated with the user. Such instruments may include instruments owned by, controlled by, and/or selected by the user, and/or instruments that satisfy one or more criteria associated with the user (e.g., parameters selected by the user or associated with the user based on user information such as a preference determined by a processor).

Database 80 may store hedge information associated with one or more orders, payments, and/or groups of orders and/or payments.

While the databases are shown coupled to a single server, the databases may also operate among several servers. The databases may communicate with a plurality of modules and servers, which may also function collectively or separately to perform the features and functions described here.

An Exemplary Method

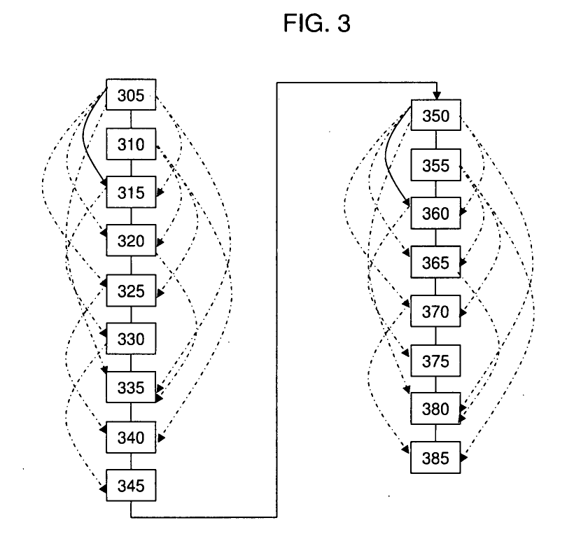

FIG. 3 depicts a flow diagram according to at least one embodiment of the methods disclosed herein. It should be understood that each function(s) described for each block may be performed using a module capable of performing that function, e.g., according to methods described for each module above.

In block 305, the system 100 may receive login information, e.g., from a user. For example, the user may access the system to log in to an account of the user managed by the system. The login information may be any information for use in authenticating a user and providing thereto one or more of the functions disclosed herein. The login information may be, for example, a user ID, password, biometric data, etc. The login information may be submitted by a user with a user interface screen that includes therein at least one form element, such as an input field or text box, a drop down list, check box, radio buttons, action buttons, clickable images, etc., for entering login data. Following submission, the login information may be compared with previously obtained information and access to one or more of the functions may be provided based on a positive match.

In block 310, one or more bid and/or offer prices may be received, e.g., from users, e.g., for a particular product such as a currency conversion. The bids and offers may comprise an estimate by a user of a fair market price bid and offer for the product, and need not be an actual bid or offer price from a user.

The bids and offers may comprise a plurality of bid-offer pairs, each received from a user. The bid-offer pairs may be received continually from each user. The bids and offers may be received from a user at the same time or at different times. In some embodiments, a user may be deemed to have a presently valid bid-offer pair if the user has submitted a bid and offer for a particular product within a predetermined time frame of the present. The user may submit new bids and offers to replace prior bids and offers.

In block 315, one or more bids and offers may be rejected. For instance, a bid from a user having no valid corresponding offer from the user may be rejected. The bids and offers may be rejected according to any rules discussed herein. For instance, expired bids and offers may be rejected (e.g., a bid or offer that is received after a time of validity for the bid or offer specified by the submitting user).

In block 320, a fair market price may be determined for a product. For example, a fair market price may be determined from an average of the valid bid-offer pairs for the product.

In block 325, a fair market price may be updated. For example, additional bid-offer pairs from additional users or updated bid-offer pairs may be received. The fair market price may be recalculated based on the updated information.

In block 330, one or more orders may be received by the system, e.g., from one or more users. The orders may comprise offers to purchase or sell the product. Each order may specify a bid to purchase or an offer to sell a quantity of the product. The orders may not specify a price in some embodiments, as the price may be determined by the system.

In block 335, one or more users may be disconnected from the server. For such users, all bid prices, offer prices, and orders from the user may be rejected.

In block 340, the fair market price may be recalculated based on the updated information (e.g., the disconnected user).

In block 345, additional orders may be received.

In block 350, the system may match one order with another. For example, the system may match a bid with an offer for the same product.

In block 355, the system may execute a trade based on the matched orders.

In block 360, the system may send a confirmation of the trade, e.g., to the two parties who traded.

In block 365, the system may calculate a flow rate between one or more parties for one or more transactions, e.g., a price flow for two transacting parties over the course of one week.

In block 370, the system may determine an adjustment value based on the flow data.

In block 375, the system may transmit the flow information, including the adjustment value, to the users.

In block 380, the system may receive an adjustment value from one or more of the users. The users may specify that the adjustment rate is active only until the aggregate flow between the parties over a time of interest is within a specified range of zero.

In block 385, the system may process subsequent transactions for those parties using a market price adjusted by the adjustment value specified by the parties.

The example flowchart of FIG. 3 has been offered for purposes of teaching only. Accordingly, some of these steps may be changed, rearranged, deleted, or replaced with other steps where appropriate. Such modifications may be based on particular disclosure needs or specific trading architectures and configurations, for example. Such derivations are within the teachings of the present invention.

It should be appreciated that various embodiments of the invention use some or all of the actions described in the blocks of FIG. 3. The actions that are performed in those blocks may be performed in the order listed, or in any other order.

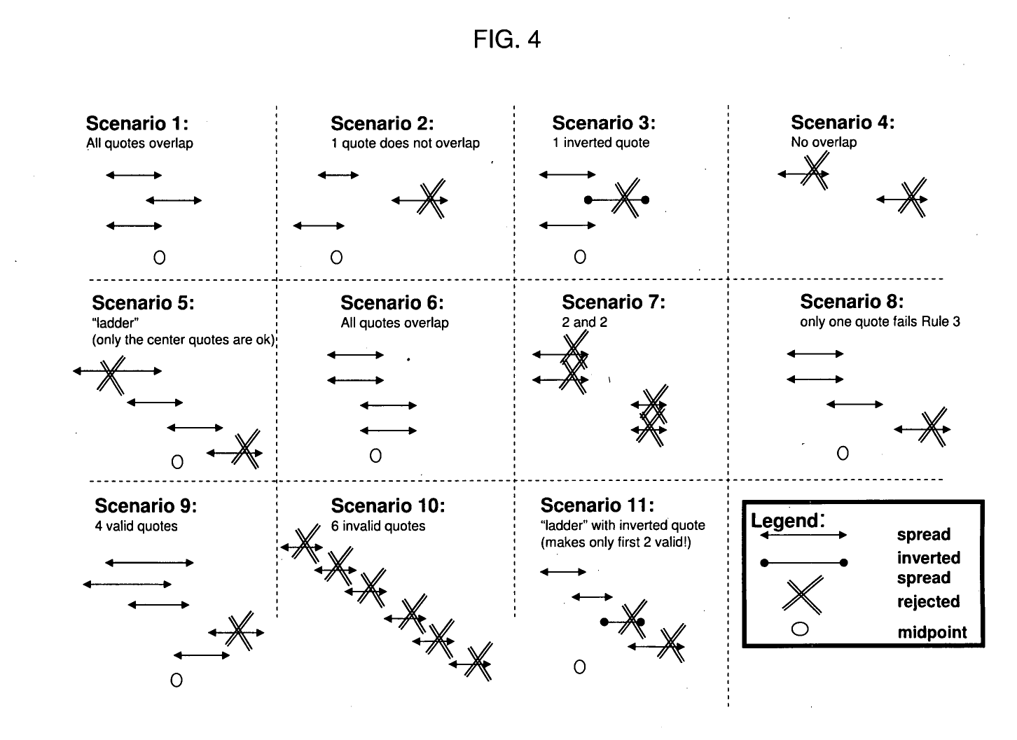

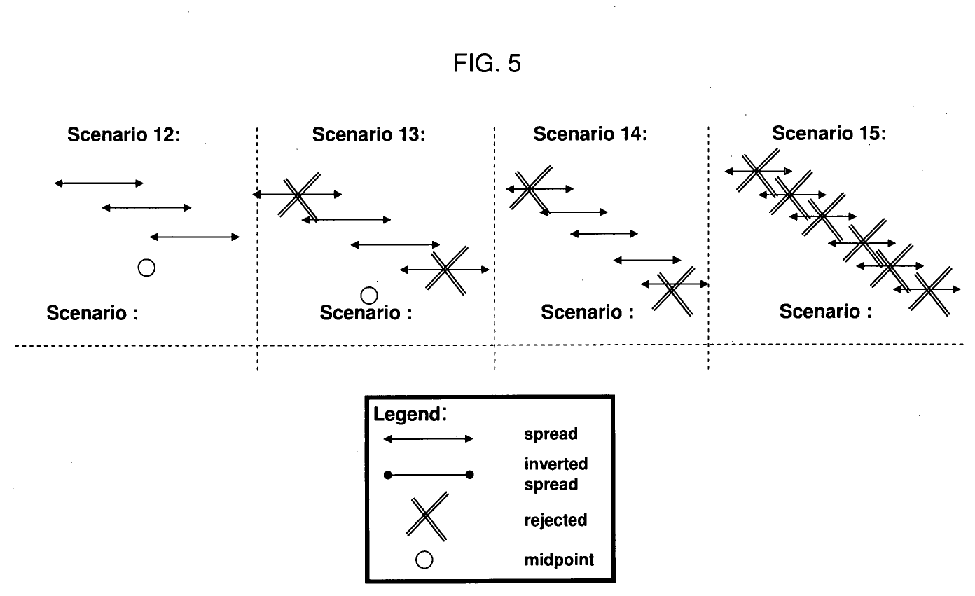

FIGS. 4-5 depict exemplary bid-offer pairs according to at least one embodiment of the methods disclosed herein. In particular, FIGS. 4-5 depict an exemplary application of rules for determining a midpoint price from various bid-offer pairs.

FIGS. 4-5 show fifteen scenarios of bid-offer pairs for a particular market (e.g., a particular currency exchange such as dollars to euros) that may be unexpired in the system at a time of interest, e.g., at a time of calculating a midpoint price for executing an order (such as 10:15 and 23.85 seconds). Each scenario may involve a different set of users and markets. In some embodiments, each pair may comprise an estimate of a fair bid price and a fair offer price for a particular currency exchange. Each pair may be received from a different user, e.g., over a network. As shown in the legend of FIGS. 4-5, various bid-offer pairs may comprise a regular spread (bid is greater than offer), inverted spread (bid is greater than offer), a rejected pair (indicated with an “x” mark). An “o” mark indicates a midpoint that may be determined for bid-offer pairs in the particular scenario. In each scenario, the x-axis may represent price, and the endpoints of each pair (e.g., arrowheads and dots) may represent bid prices and offer prices. For a double-headed arrow (e.g., representing a traditional non-inverted bid-offer pair), the offer is the right-most arrowhead (at the higher price) and the bid is the left-most arrowhead (at the lower price). Two non-inverted bid-offer pairs may be said to “overlap” if they cover at least one price in common (i.e., the line between the arrowheads of one arrow covers prices (i.e., points along the x-axis) that are also covered by the line between the arrowheads of another arrow.

According to some embodiments of the invention, the system may apply various rules to determine which bid-offer pairs may be used in a calculation of the market price. (In some embodiments, the market price may comprise a midpoint price.)

For example, in the scenarios of FIGS. 4-5, the system may reject each bid-offer pair that comprises an inverted spread. The system may also reject any un-paired bids and offers, i.e., bids (or offers) that do not have a corresponding unexpired offer (or unexpired bid) from the same user. (FIGS. 4-5 depicts only the paired bids and offers.) The system may also reject any pair that does not overlap with another pair, as described herein. For example, as shown in Scenarios 4 and 8, the system has rejected each bid-offer pair that does not overlap with any other pair.

In some embodiments, the system may determine the bid-offer pairs that otherwise remain eligible for use in calculating a midpoint price, e.g., after rejecting any expired, unpaired, or non-overlapping pairs. Of the remaining “otherwise eligible” bid-offer pairs, the system may apply an “overlapping” requirement. For example, the system may reject any “otherwise eligible” bid-offer pairs that do not overlap with at least half (e.g., 50%) of the remaining “otherwise eligible” bid-offer pairs (e.g., not counting the bid-offer pair at issue).

For example, in scenario 5, all four pairs may be “otherwise eligible” pairs. However, the system may reject the first pair (i.e., the left-most pair) because it overlaps only with the second pair and not the third or fourth pairs. Thus, the first pair overlaps with only one of the remaining three pairs (not including the first pair), which is only 33% of the remaining pairs. Similarly, the system may reject the fourth pair because it overlaps with only the third pair, and not the first and second pairs. The system may accept the second pair because it overlaps with the first and third pair, which is ⅔ of the remaining pairs (i.e., two thirds of the 2^{nd}, 3^{rd}, and 4^{th} pairs). Similarly, the system may accept the third pair because it overlaps the second and fourth pairs. Accordingly, the system may determine that the second and third pairs are qualified for calculating a midpoint price. For purposes of discussion, these pairs that satisfy all the conditions for being considered in a midpoint calculation may be considered “sufficiently overlapping” or “qualified” pairs.

As shown in Scenario 5, the midpoint appears between the right-most arrowhead (i.e., offer price) of the second pair and the left-most arrowhead (i.e., bid price) of the third pair. The numerical price of the midpoint may comprise the average of the bid and offer prices of the second and third pairs.

As shown in Scenarios 7, 10, and 15, in some cases the system may determine that there are no qualifying or sufficiently overlapping bid-offer pairs. In some embodiments, the system may decline to determine a midpoint in such circumstances. In some embodiments, the system may deny, cancel, return, or otherwise decline to execute an order at a time when the system cannot (or does not or determines that it should not) calculate a market price.

It should be appreciated that the system may calculate a market price using any of a variety of algorithms. In some embodiments, the system may determine a market price that is equal to a midpoint price, in which the midpoint is calculated to be equal to a calculated average of the bids and offers of the “qualified” pairs. In some embodiments, the system may determine a midpoint price based further on a time. For example, the system may calculate a time-weighted average that weights each bid and offer value based on a time that the bid or offer was determined, submitted (e.g., by a user), or received.

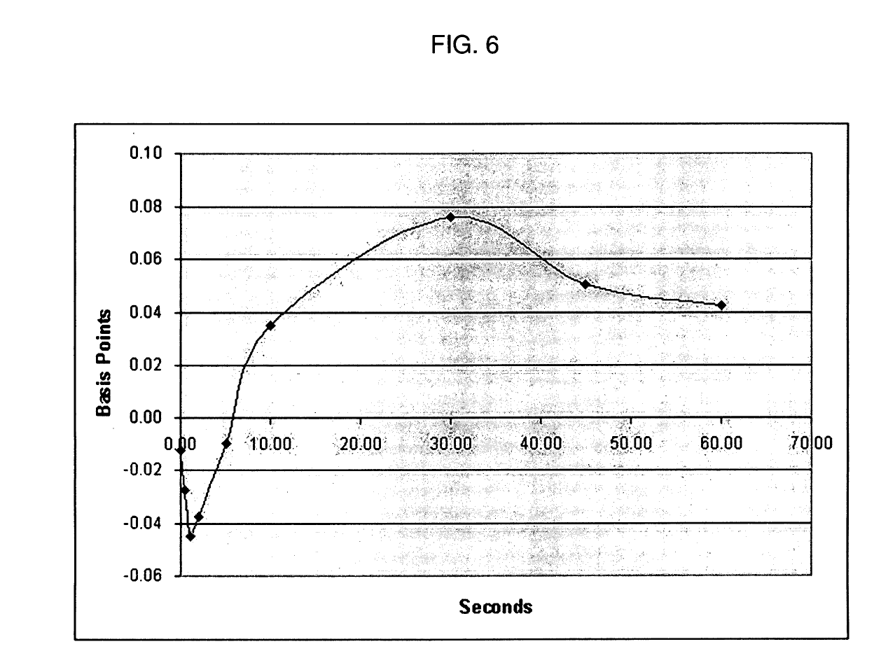

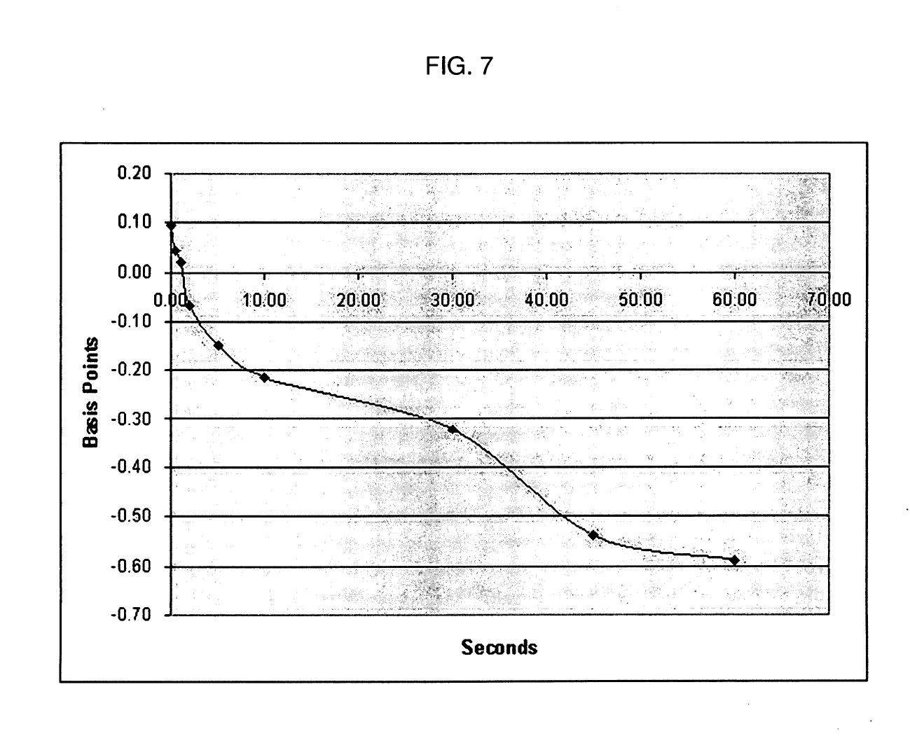

FIGS. 6 and 7 depict an exemplary graph showing changes in a market price over time according to at least one embodiment of the methods disclosed herein. The x-axis shows time in seconds, and the y-axis shows a price (as measured in number of basis points from a normalized “zero” value). In some embodiments, the y-axis may indicate price in pips, which may comprise a fractional amount of a basis point.

As described herein, “price flow” may refer to a change in price (e.g., market price) over time. The price flow may indicate an extent to which one party effectively “gained” or “lost” after executing a transaction, such as a purchase or sale of a product to another party. (For example, if a purchased asset rises in price, then the owner of the purchased asset effectively realizes a “gain” equal to the increase; and if a sold asset rises in price, then the prior owner of the asset failed to realize such gain.) FIGS. 6 and 7 show exemplary graphs of price flow over time starting at a particular time, such as a time of executing a transaction (e.g., executing an order to exchange one currency for another between two parties such as banks).

As shown in FIG. 6, a price (e.g., a market price such as a market exchange rate) at time t=0 may be normalized to zero for purposes of the graph. (These graphs focus on the change in price rather than the actual price.) The price may comprise a price of a single item (e.g., a market price of a security) or an aggregate price of a group of items (e.g., a weighted average market price of all items purchased from and/or sold to a specific party by another party). For instance, the price flow graph of FIG. 6 may show the change in price of all currencies purchased (and/or sold) by one bank from (and/or to) another bank. (It should be appreciated that price flow of purchases and sales would have to be adjusted so that disadvantageous movements in a purchase price (i.e., decreases in a price after purchase) do not counteract disadvantageous movements in a sale price (i.e., increases in a sale price after sale.)

After ten seconds, the graph shows that the market price has increased by about 0.037 basis points from its price at t=0. After 60 seconds (t=60), the price decreases to 0.042 basis points greater than the price at t=0. In one example, the graph of FIG. 6 may reflect the price of all dollars purchased by one bank in exchange for Euros from another bank in a particular day, or during a particular hour. The zero price may reflect the aggregate purchase price of those dollars at the time of purchase. (The total price of the purchased dollars may be $7,000,000, although it is normalized to 0.0 for purposes of the graph.) In some embodiments, all prices executed in the market may reflect a “market price.” Accordingly, $7,000,000 (or zero on the graph) may reflect the “market price” at t=0. As time increases the market price increases above $7,000,000, such that after 60 seconds the market price of the $7,000,000 is now 0.042 basis points above $7,000,000. Accordingly, the owner of the $7,000,000 realizes a 0.042 basis point increase in the market value of the purchased dollars. Accordingly, this graph shows a positive “price flow” for the purchaser of the dollars. A different graph showing the sale of the $7,000,000 from the perspective of the seller may indicate a corresponding negative “price flow.”

As shown in FIG. 7, a price (such as an exchange rate) starts at t=0 at 0.10 basis points greater than a normalized price (0.0 basis points). After ten seconds, the price has decreased to 0.22 basis points below the zero price. After 60 seconds, the price has decreased further to 0.58 basis points below zero.

Although the price flow continues to change over time, e.g., as the market price for the product continues to change over time, a price flow may be determined for a particular transaction or plurality of transactions, e.g., between two users. For example, the flow may be determined to be the value of the price flow at a predetermined time after a transaction, such as 0.5, 1, 2, 5, 10, 15, 20, 30, 45, and 60 seconds after a transaction. In this scenario, it may be irrelevant how the price changed between the initial time and the final time of interest, as the initial and final times may be the only relevant times for purposes of determining flow.

In some embodiments, flow may be determined to be an integral of the flow graph during a period of time (e.g., during the first 0.5, 1, 2, 5, 10, 15, 20, 30, 45, or 60 seconds after a transaction), in which the initial price is zero. In this scenario, an increase in price above the transaction price during a first period of time may balance out a decrease in price below the transaction price during a second period of time.

In some embodiments, the system may determine and output information such as price flow charts of FIGS. 6 and 7, and this information may be transmitted to one or more parties. In some embodiments, the information may be used to provide information about an adjustment in a market price between the two users so that aggregate flow between the parties is close to zero over time. Accordingly, if one user yielded high positive flow against another party during one day, the system may output the graphs and indicate a recommended adjustment in the market price for transactions between the parties in a second day. For example, the recommended adjustment may be an adjustment that, assuming a consistent volume of transactions between the two parties in the second day (and neutral net price flow), the price flow of all transactions between the two days would be close to zero. Thus, if the first user yielded a price flow of positive 0.01 basis points in the first day against a second party, the market price between the two parties may be adjusted in favor of the second party by 0.01 basis points for all transactions between the parties in the second day. (For example, the market price could be adjusted so that the second party buys from the first party at 0.01 basis points below the market price and sells to the first party at 0.01 basis points above the market price.)

In some embodiments, parties may wish to have substantially zero net flow between them over time so that neither has an advantage over the other in the long run. Such a system may encourage users to participate in the system, since the rules of the system may prohibit one party from yielding substantial market gains over another. In some embodiments, users may wish to participate in the system to buy and sell products (such as commodities or currencies) not to make a profit on those products directly, but to hedge a large short or long position in those products, e.g., in another market.

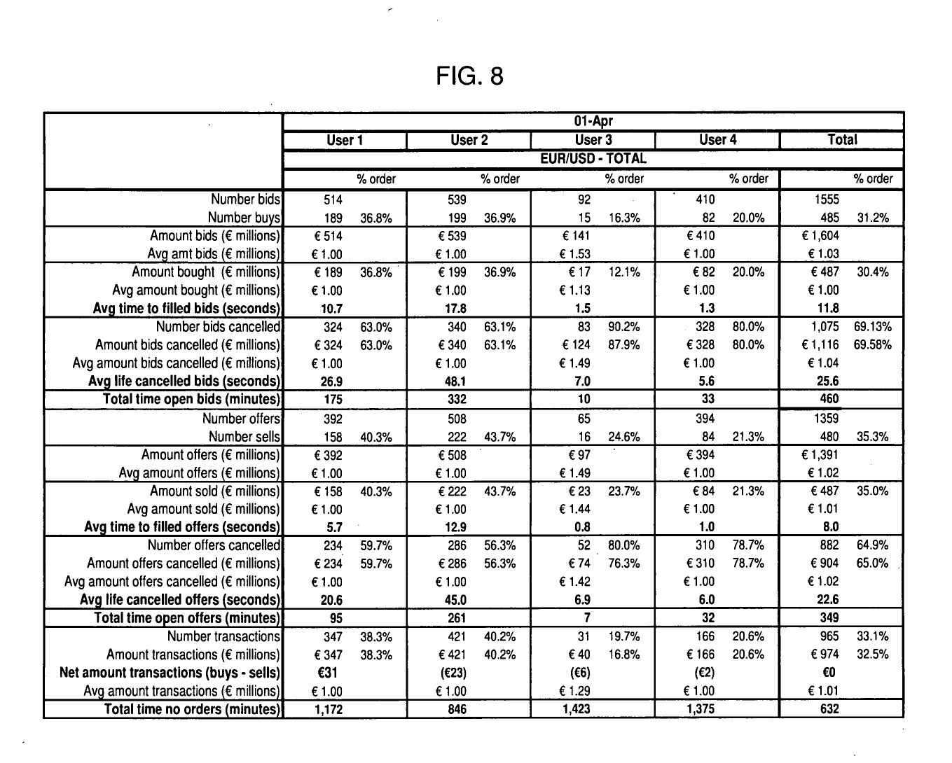

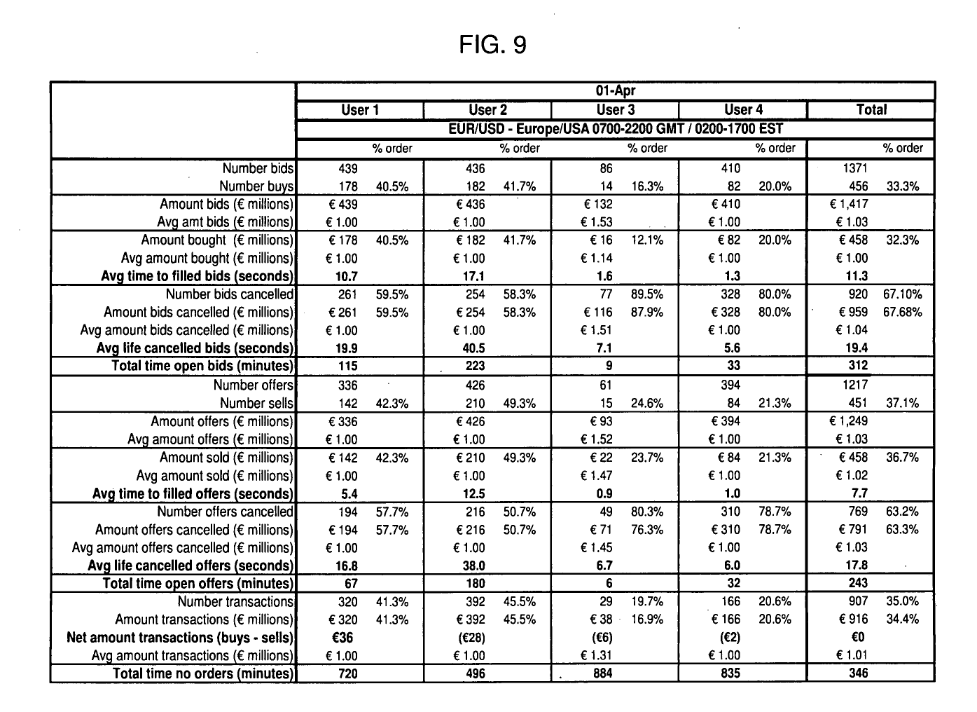

FIGS. 8 and 9 depict exemplary tables showing trading information that may be determined according to at least one embodiment of the methods disclosed herein. For example, a plurality of users (e.g., users 1-4) may trade currencies with one another on an exchange such as server 2. The system may track information collectively and individually over a period of time (such as one day, e.g., April 1) for one or more currencies, e.g., in a particular market or exchange. The information may include such information as number of bids and offers; number of buys and sells; amount of bids and offers; amount purchased and sold; number of bids and offers cancelled; amount of bids and offers cancelled; average amount of bids and offers cancelled; total time bids or offers were open; number of transactions; amount of transactions; net amount of transactions (e.g., buys minus sells); total time no orders; and other information. FIG. 8 shows such information for a Euro-dollar conversion for total transactions on the market. FIG. 9 shows such information for the Euro-dollar conversion at a particular time (7 am-5 pm GMT), e.g., on a London exchange.

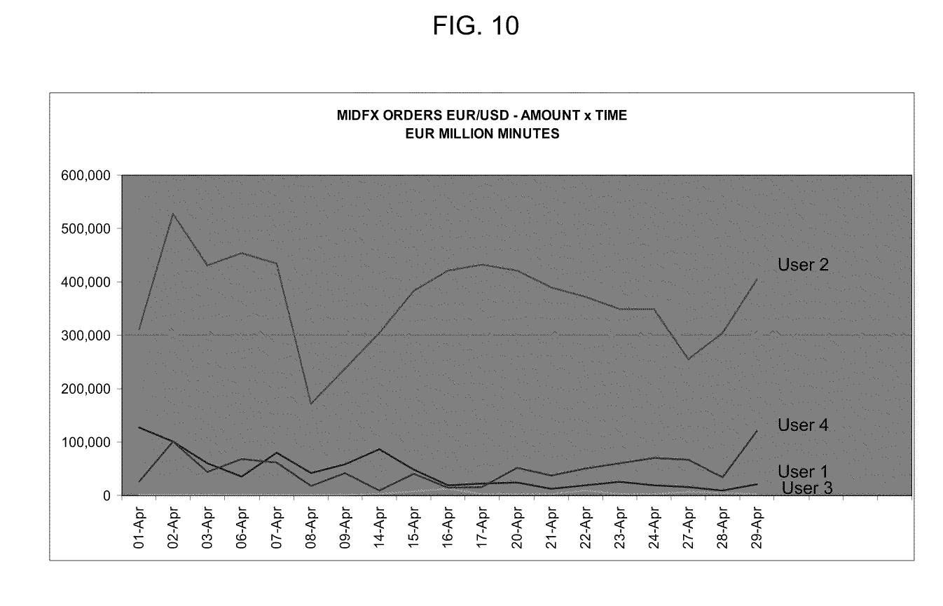

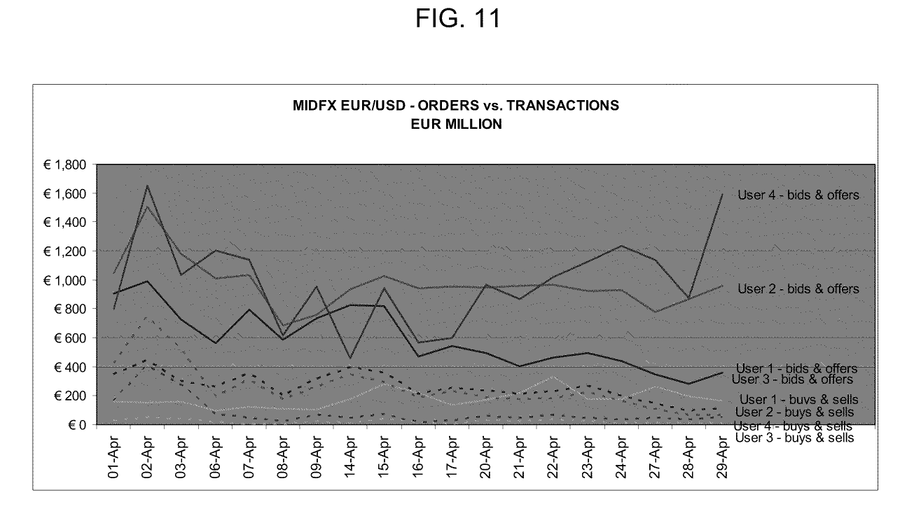

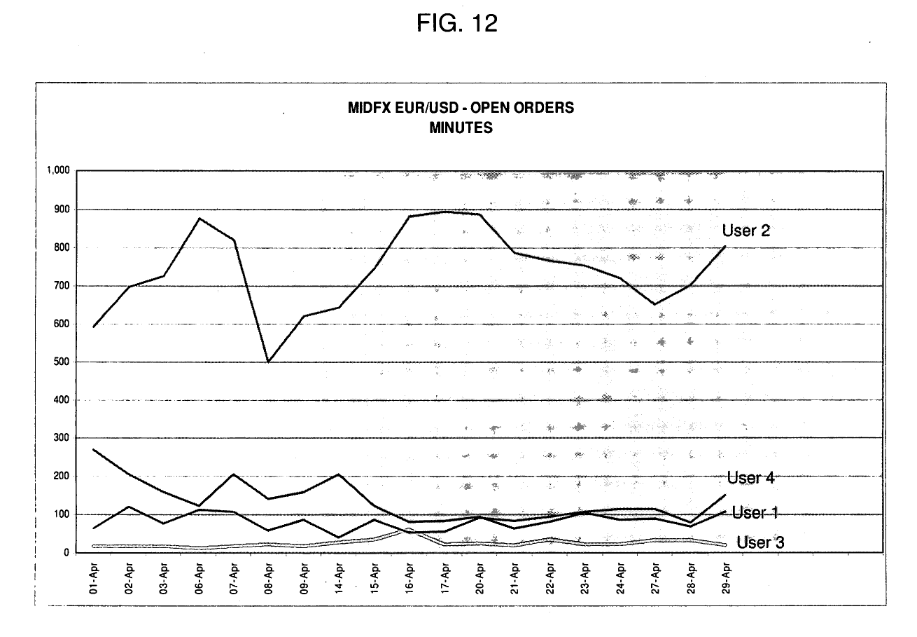

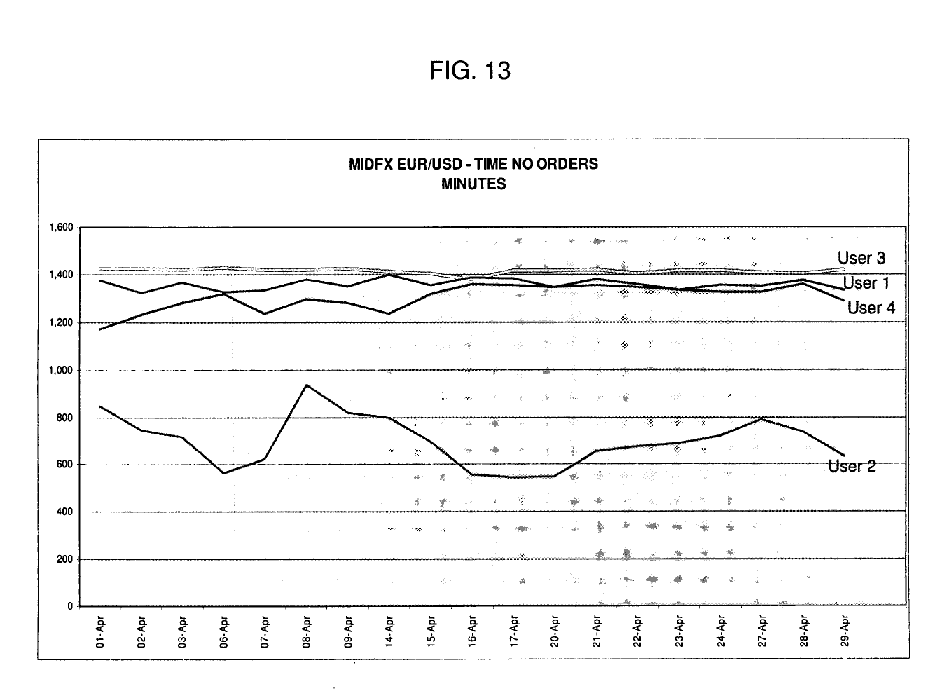

FIGS. 10-13 depict exemplary graphs showing trading information that may be determined according to at least one embodiment of the methods disclosed herein. In the specific embodiments shown in FIGS. 10-13, information about trades of a particular currency exchange (e.g., Eur/USD) among four different users of a currency exchange may be collected, processed, and output in graphs (e.g., and provided to users in a webpage). FIG. 10 shows a plot of an amount of orders times time (e.g., duration of the order) in the y-axis on a day by day basis (days in the x-axis). As shown in FIG. 10, user 2 had the highest value of orders times time each day. FIG. 11 shows the number of orders (solid lines) and the number of transactions (dotted lines) in the y-axis on a day by day basis (in the x-axis). Here, users 2 and 4 had the greatest number of bids and offers, while users 1 and 2 typically had the greatest number of buys and sells. FIG. 12 shows the number of open order minutes (y-axis) on a day-by-day basis (x-axis). Here, user 2 had by far the most open order minutes, meaning that user 2 tended to have more orders open for longer than the other users. FIG. 13 shows the amount of time (y-axis) per day (x-axis) that each user had no orders open. As shown here, user 2, who had the most open order minutes, also had the lowest incidence of no orders pending.

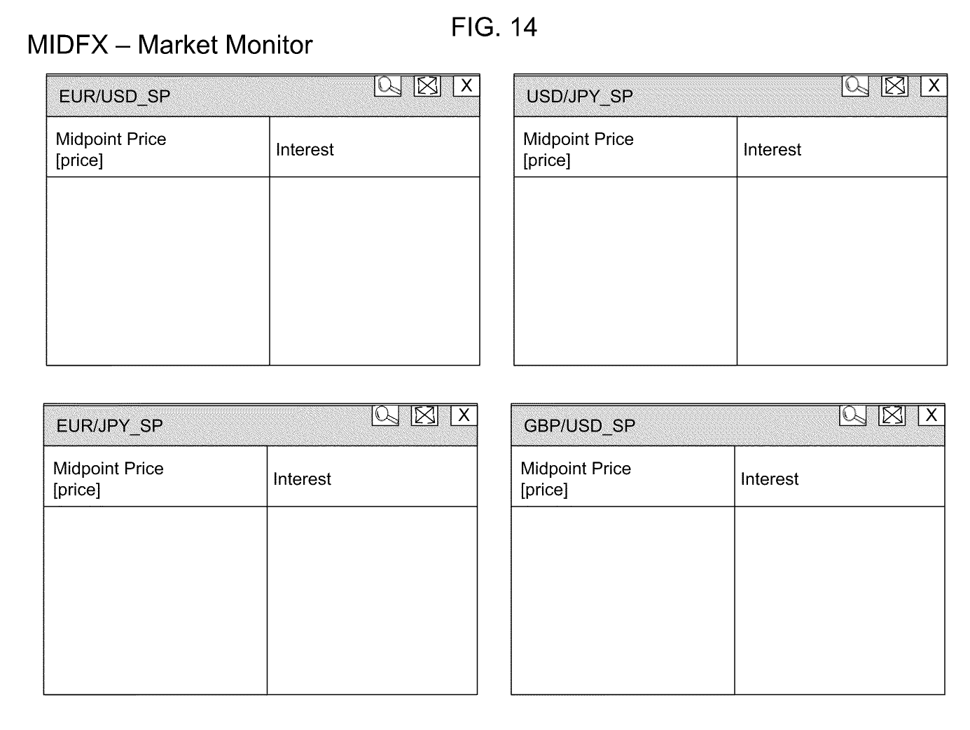

FIGS. 14-25 depict exemplary interfaces for managing and communicating order information according to at least one embodiment of the invention. In some embodiments, such user interface screens may be displayed to one or more users and/or one or more system administrators. The screens may be updated continually or continuously, e.g., in real time. Accordingly, in various embodiments, each screen comprise a snapshot of order and market information at a particular instant of time. In some embodiments, users may be precluded from viewing various order information.

As shown in FIG. 14, information about different exchange rates may be displayed in different windows.

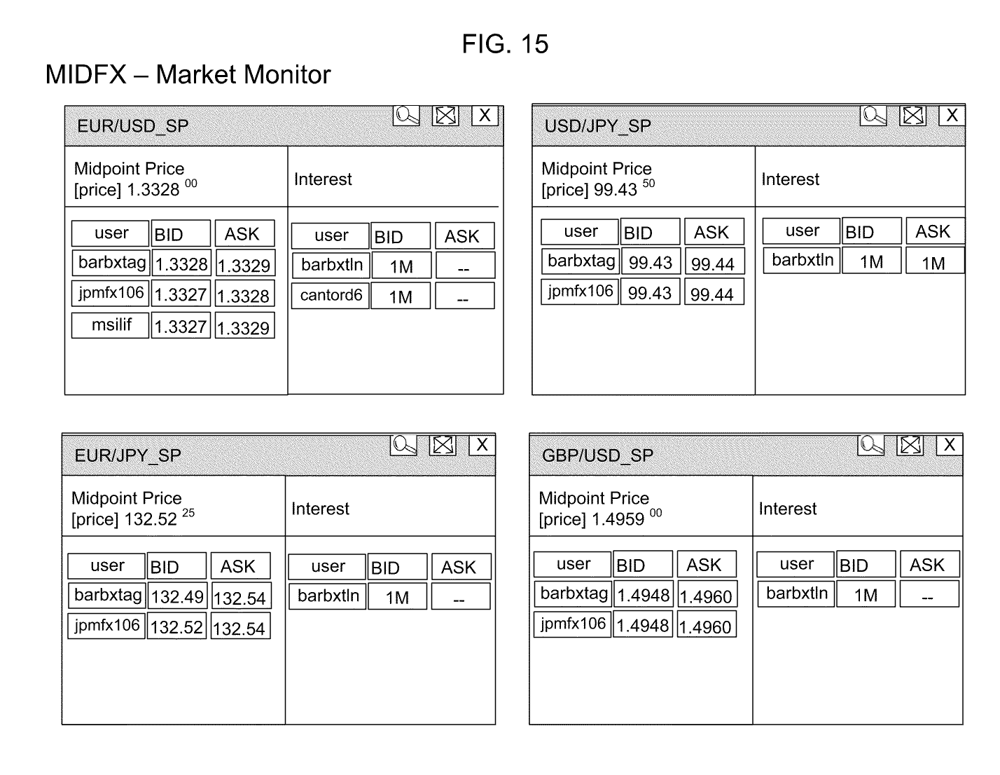

FIG. 15 shows various bid-offer pairs submitted by various users for a plurality of currency exchanges (each currency exchange having a separate window). In the left part of each window, the bid-offer pairs for each user may comprise the user's assessment of a fair bid price and a fair offer price at a particular time. As shown in the left side of each window, a midpoint price may be calculated for each currency exchange, e.g., as described herein (such as by a straight average of all currently valid bids and offers of the valid bid-offer pairs for that currency exchange). The midpoint price may comprise the market price at which orders will be executed at the particular instant in time. As shown in the right side of each window, the “interest” section may show any active bids and offers, each bid and offer specifying a quantity.

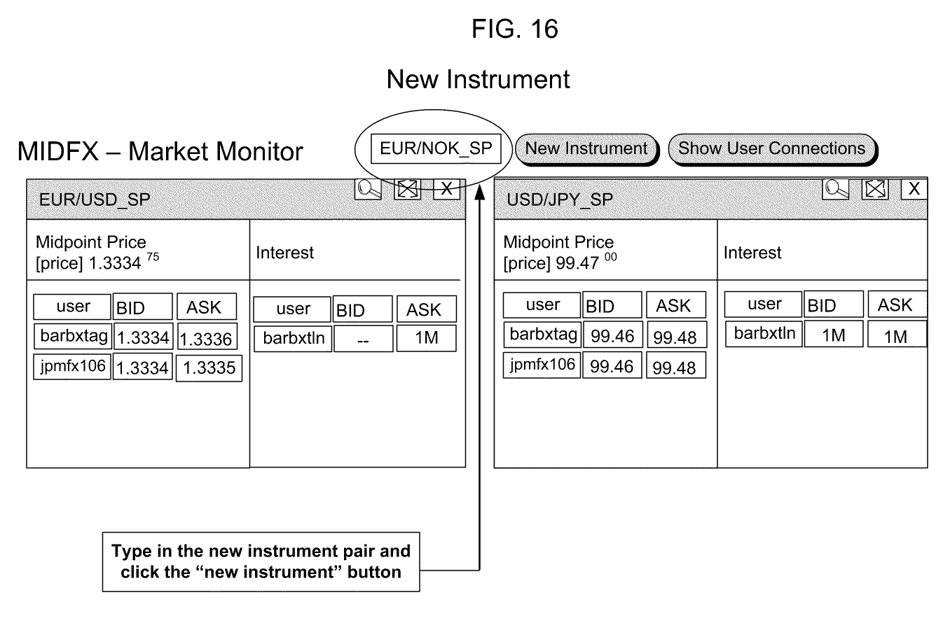

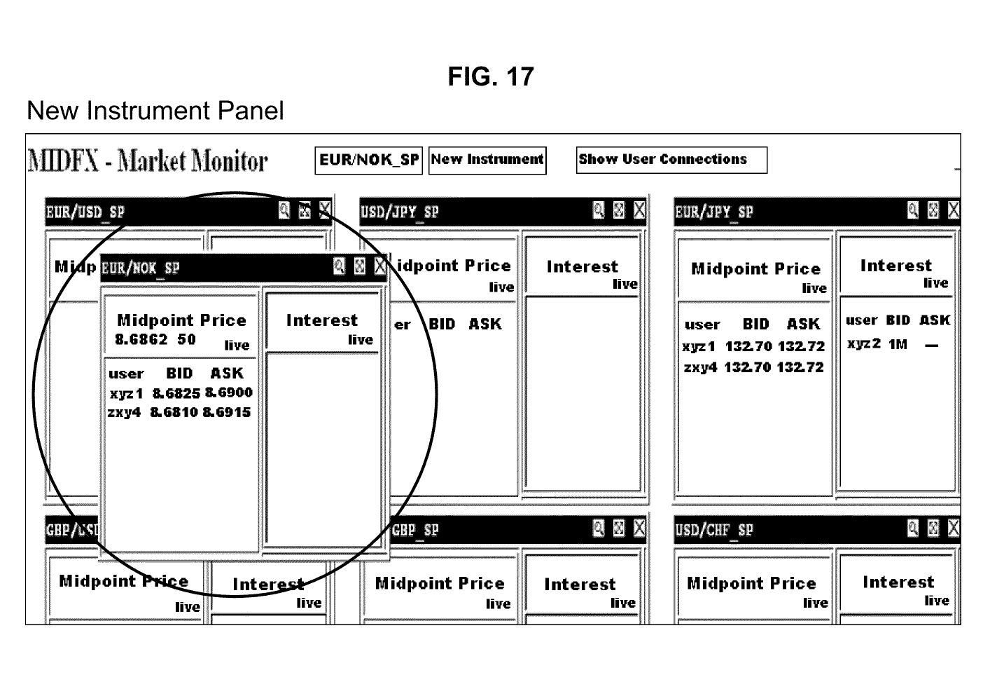

As shown in FIG. 16, a user of the system (or system admin) may type in or select a new instrument, such as a financial instrument such as a currency conversion pair. As shown in FIG. 17, bid-offer pairs and calculated midpoints may be shown for the selected instrument.

As shown in FIG. 17, a “user overview” window may show information about each user, e.g., each user's connection to the system. In some embodiments, if a user's connection to the system is disrupted (e.g., the user is disconnected), then the user's orders and bid-offer pairs may become immediately invalid and withdrawn.

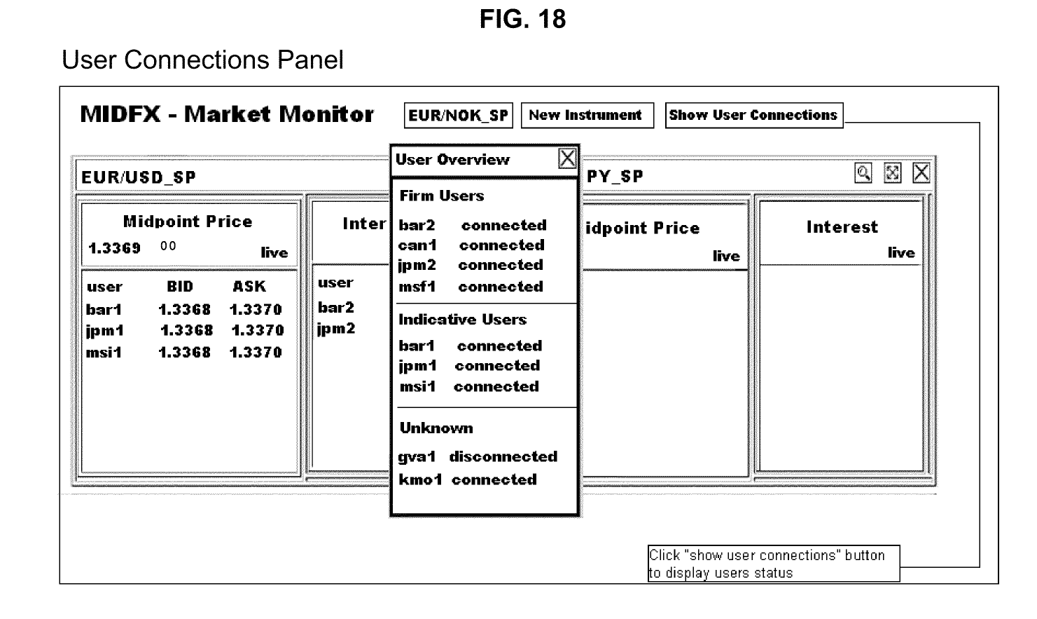

As shown in FIG. 18, each window may be maximized to show more information about the instrument, such as trade history. The trade history may show a transaction id for each trade, the time of the trade, the price (e.g., determined midpoint price) at which the trade executed, the quantity traded, and the identity of the buyer and seller. In some embodiments, the buyer and seller may remain anonymous, at least until the transaction is completed. In some embodiments, users may be provided transaction information (e.g., identities of buyers and sellers) only on an aggregate basis, e.g., such as the information shown in FIGS. 8-9 and FIGS. 10-13.

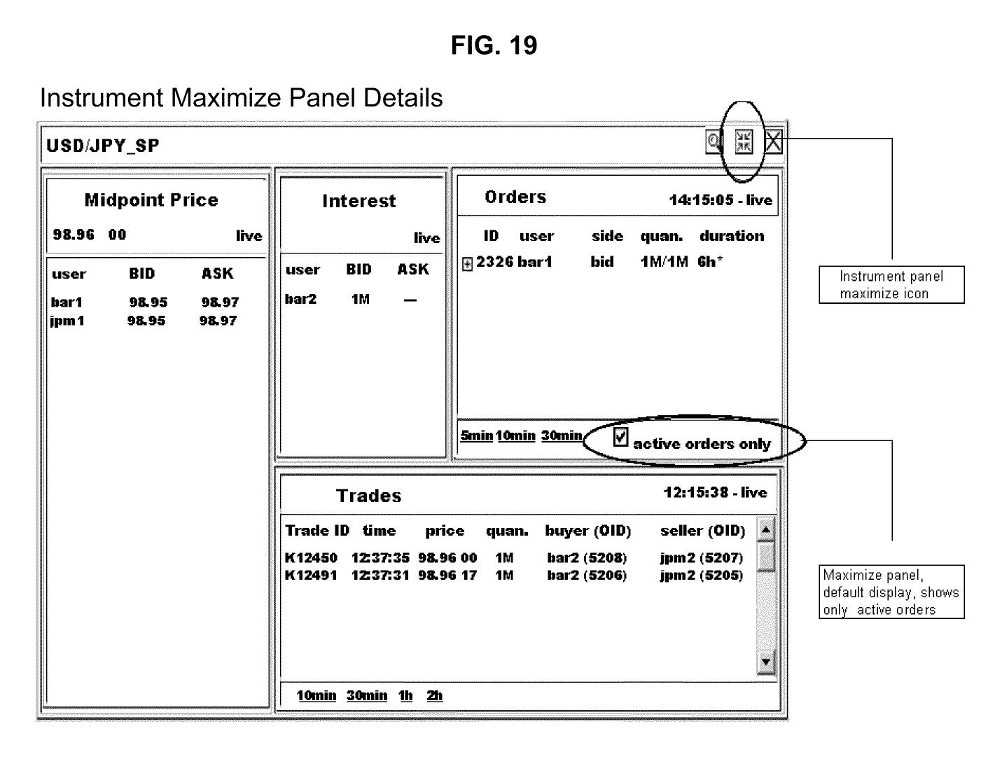

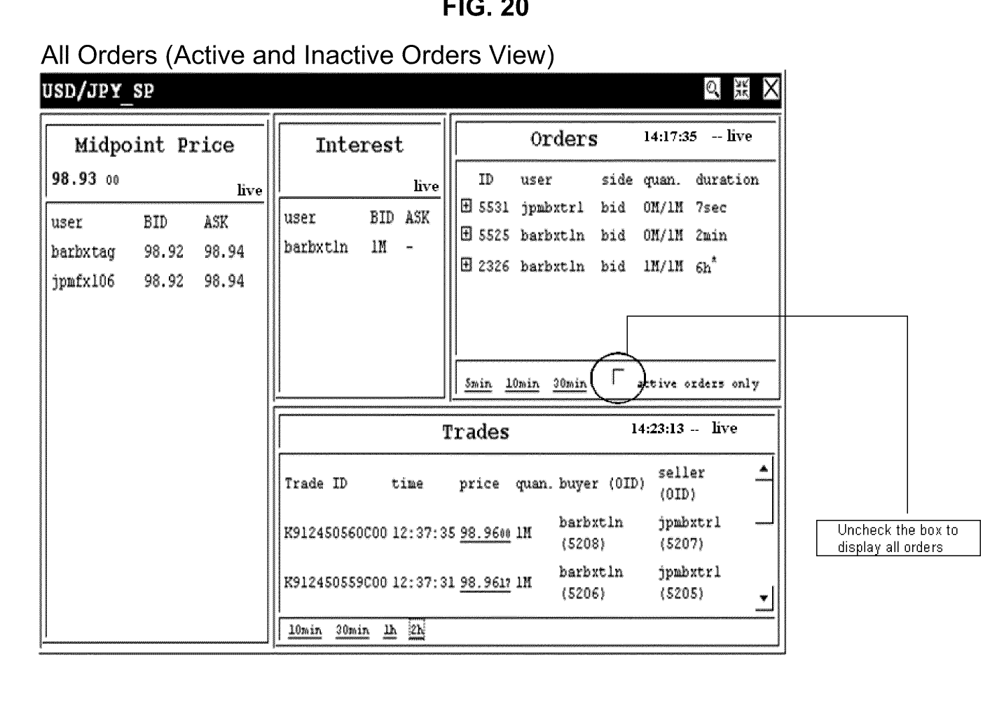

As shown in FIGS. 19-20, additional detail about active orders (FIG. 19) and/or all orders (FIG. 20) may be provided. The information may include the quantity of the order, the user who submitted the order, and the duration of the order (e.g., time specified by the user for the order to be open, or in some embodiments the remaining time until the order expires).

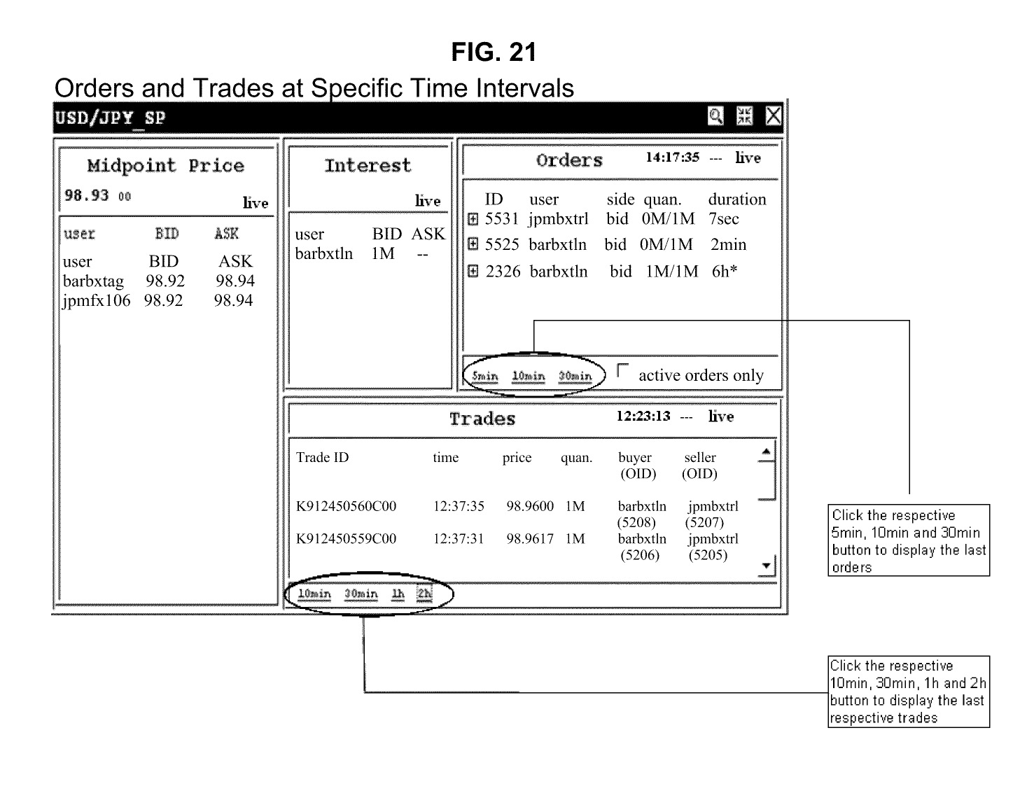

As shown in FIG. 21, additional information about trades and orders may be displayed according to specific time intervals such as 5, 10, and 30 minutes.

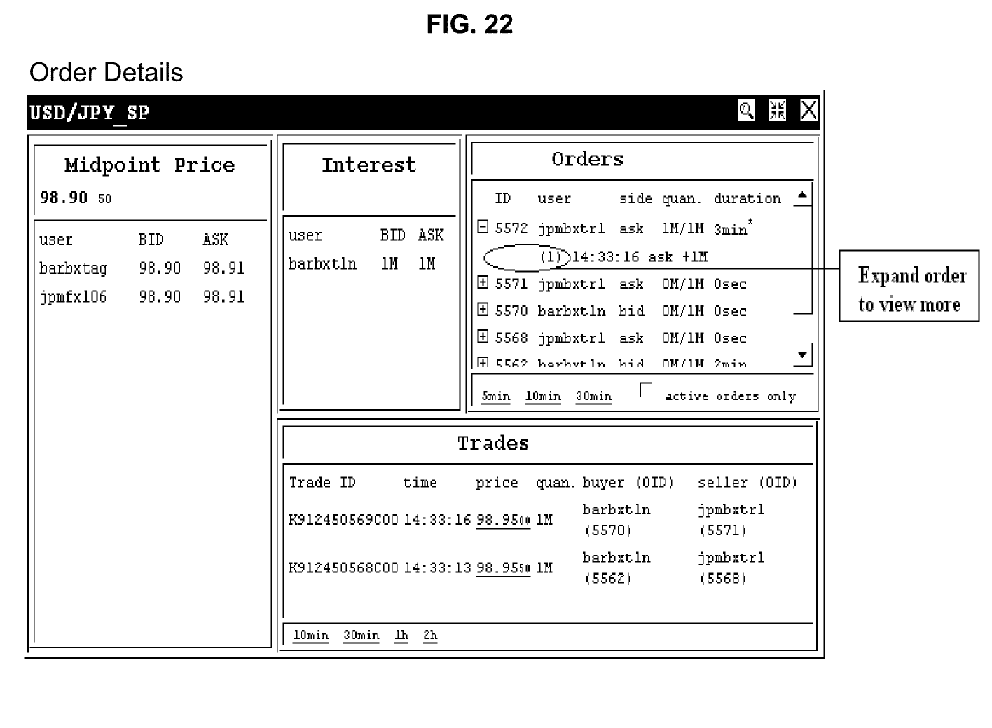

As shown in FIG. 22, orders may be selected to cause the display of additional information about the order (or trade), such as the time of submission.

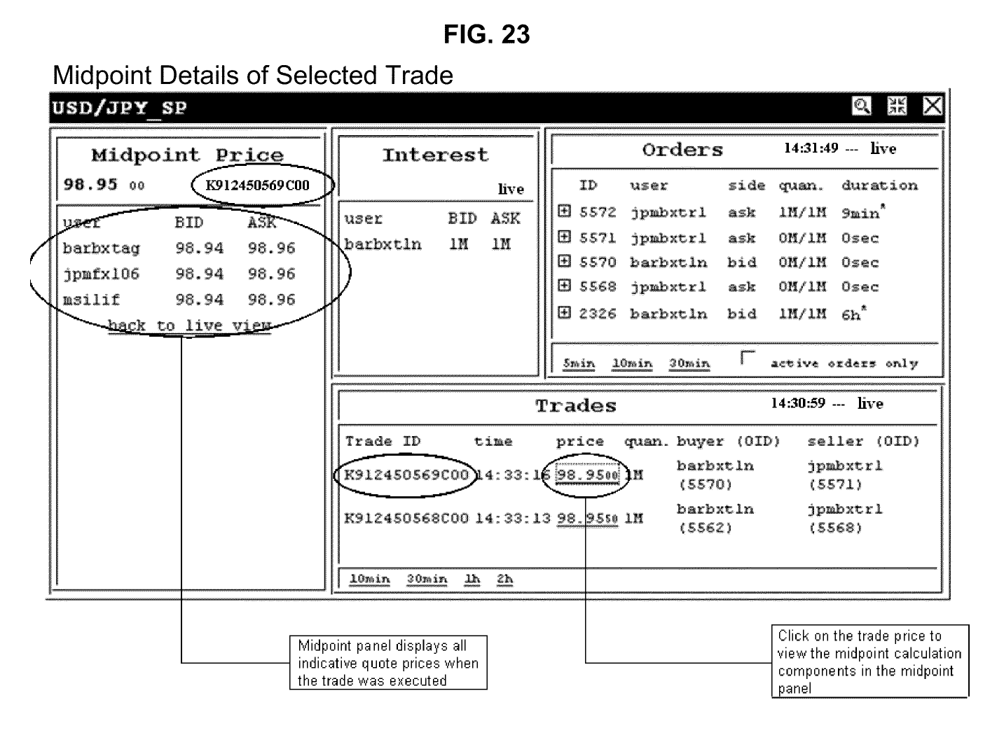

As shown in FIG. 23, order prices (e.g., market prices, such as market prices determined according to a midpoint) may be selected to cause the display of additional information about the midpoint price. For example, the interface may display the components (e.g., bid-offer pairs) that went into the calculation of the midpoint price.

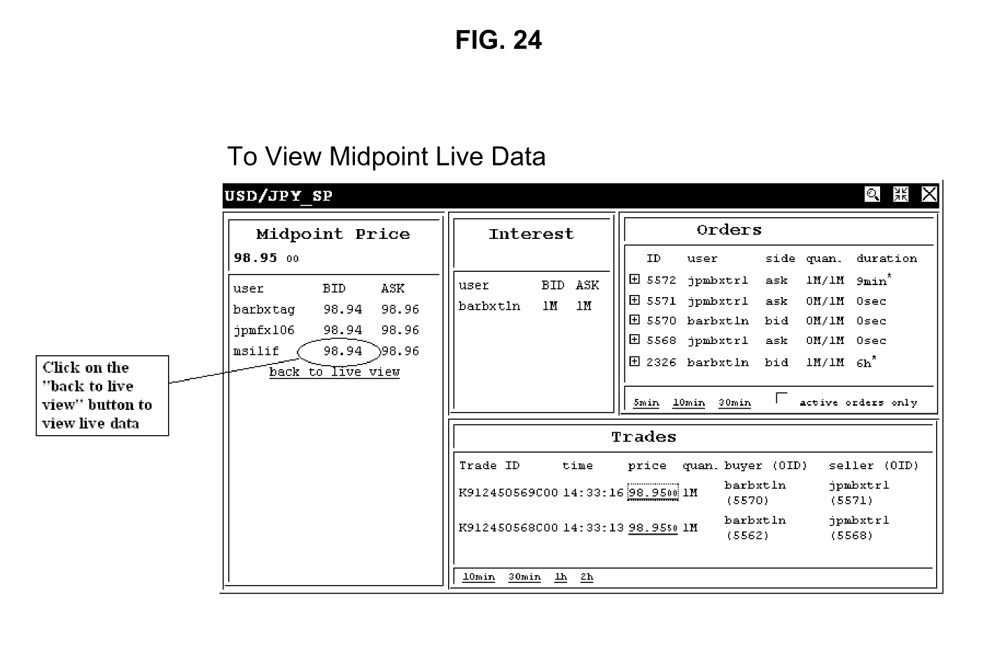

As shown in FIG. 24, market prices (e.g., midpoint prices) may be viewed in real time or historically.

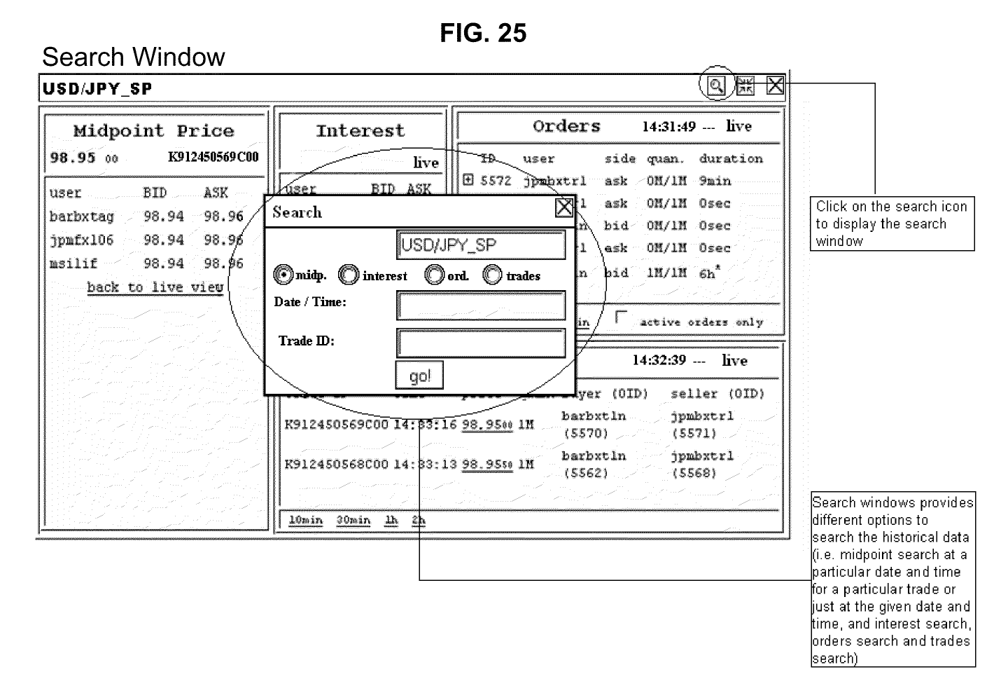

As shown in FIG. 25, market, order, and trade information may be searched. For example, a search for a particular product (e.g., a specific currency conversion) may cause the interface to display historical data associated with orders and trades for the product by users.

XIX. Alternative Technologies

It will be understood that the technologies described herein for making, using, or practicing various embodiments are but a subset of the possible technologies that may be used for the same or similar purposes. The particular technologies described herein are not to be construed as limiting. Rather, various embodiments contemplate alternate technologies for making, using, or practicing various embodiments.

Modifications, additions, or omissions may be made to the method without departing from the scope of the invention. The method may include more, fewer, or other steps. Additionally, steps may be performed in any suitable order without departing from the scope of the invention.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

XX. References

The following patents and patent applications are hereby incorporated by reference herein for all purposes: U.S. Pat. No. 6,560,580; and U.S. patent application Ser. No. 09/801,495 filed Mar. 8, 2001, Ser. No. 10/301,527 filed Nov. 21, 2002, Ser. No. 10/699,858 filed Oct. 31, 2003, Ser. No. 11/122,510 filed May 4, 2005, and Ser. No. 12/189,266 filed Aug. 11, 2008. For example, the trading and communication systems and methods disclosed in the above-referenced patents and patent applications may be used to perform trading and communication embodiments of the systems and methods described herein.

What is claimed is:

1. An apparatus, comprising:
at least one processor; and
a memory that stores instructions which, when executed by the at least one processor, directs the at least one processor to:
receive from a plurality of users of an electronic trading system a corresponding plurality of bid-offer pairs for a currency exchange between a first currency and a second currency, the plurality of users comprising a first user and a second user, each bid-offer pair comprising:
(1) a bid price comprising an estimate of a fair bid price for purchasing the first currency in units of the second currency,
(2) an offer price comprising an estimate of a fair offer price for selling the first currency in units of the second currency,
the bid-offer pair defining (a) a range of prices between the offer price and the bid price and (b) a quote spread comprising the difference between the bid price and the offer price;
determining from the plurality of bid-offer pairs a set of overlapping bid-offer pairs, in which the act of determining the set of overlapping bid-offer pairs comprises:
(1) determining that the bid price and the offer price of each bid-offer pair in the set of overlapping bid-offer pairs is unexpired during the time of interest;
(2) determining whether any of the bid-offer pairs comprises a bid price that is higher than the offer price of the bid-offer pair;
(3) for each bid-offer pair, determining that the bid-offer pair comprises a quote spread that is less than a predetermined threshold; and
(4) determining from the plurality of bid-offer pairs a set of qualifying bid-offer pairs, the set of qualifying bid-offer pairs comprising each bid-offer pair of the plurality of bid-offer pairs that satisfies each of the following conditions:
(a) the bid price of the bid-offer pair and the offer price of the bid-offer pair are both unexpired at the time of interest;
(b) the bid price of the bid-offer pair is lower than the offer price of the bid-offer pair;
(c) the bid-offer pair comprises a quote spread that is less than a predetermined threshold;
(5) determining from the set of qualifying bid-offer pairs a set of overlapping bid-offer pairs, in which each overlapping bid-offer pair comprises a range such that (i) the number of bid-offer pairs having a range that overlaps the range of the bid-offer pair is at least half of (ii) the number of eligible bid-offer pairs minus one, in which two ranges overlap if they both include at least one price in common;
determining an exchange rate for converting the first currency into the second currency based on the set of overlapping bid-offer pairs, in which the act of determining the exchange rate comprises calculating an average of the bids and offers in the set of overlapping bid-offer pairs;
receiving from the first user a first order to purchase the first currency in exchange for the second currency, in which the order to purchase is unexpired during the time of interest;
receiving from the second user a second order to sell the first currency in exchange for the second currency, in which the order to sell is unexpired during the time of interest;
matching the first order and the second order;
executing a trade between the first user and the second user based on the act of matching; and
transmitting a confirmation of the executed trade to the first user and the second user.

2. The apparatus of claim 1, in which each bid price and each offer price is associated with a corresponding time duration, and in which the act of determining that the bid price and the offer price of each bid-offer pair in the set of eligible bid-offer pairs is unexpired during the time of interest comprises:
determining, that the time of interest is within the time duration associated with each bid price and offer price.

3. The apparatus of claim 1, in which the set of qualifying bid-offer pairs comprises a bid-offer pair from the first user and a bid-offer pair from the second user.

4. The apparatus of claim 1, in which the order to purchase comprises a first quantity of units of the first currency, and the order to sell comprises a second quantity of units of the first currency.

5. The apparatus of claim 1, in which the first order specifies a first quantity and the second order specifies a second quantity, in which the act of executing the trade comprises executing a trade between the first user and the second user an a volume equal to the lesser of the first quantity and the second quantity.

6. The apparatus of claim 1, in which a submission of an order by a user is not revealed to any other user until after the order is executed.

7. The apparatus of claim 1, in which the exchange rate is equal to the average of the bids and offers in the set of overlapping bid-offer pairs

8. The apparatus of claim 1, in which the exchange rate is equal to a time-weighted average of the bids and offers in the set of overlapping bid-offer pairs, in which the bids and offers received at a time closer to the time of interest are weighted more heavily than the bids and offers received at a time further away from the time of interest.

9. A method comprising:
receiving from a plurality of users of an electronic trading system a corresponding plurality of bid-offer pairs for a currency exchange between a first currency and a second currency, in which the plurality of bid-offer pairs is received by at least one processor over a network, the plurality of users comprising a first user and a second user, each bid-offer pair comprising:
(1) a bid price comprising an estimate of a fair bid price for purchasing the first currency in units of the second currency,
(2) an offer price comprising an estimate of a fair offer price for selling the first currency in units of the second currency,
the bid-offer pair defining (a) a range of prices between the offer price and the bid price and (b) a quote spread comprising the difference between the bid price and the offer price;
determining by the at least one processor from the plurality of bid-offer pairs a set of overlapping bid-offer pairs, in which the act of determining the set of overlapping bid-offer pairs comprises:
(1) determining by the at least one processor that the bid price and the offer price of each bid-offer pair in the set of overlapping bid-offer pairs is unexpired during the time of interest;
(2) determining by the at least one processor whether any of the bid-offer pairs comprises a bid price that is higher than the offer price of the bid-offer pair;
(3) for each bid-offer pair, determining by the at least one processor that the bid-offer pair comprises a quote spread that is less than a predetermined threshold; and
(4) determining by the at least one processor from the plurality of bid-offer pairs a set of qualifying bid-offer pairs, the set of qualifying bid-offer pairs comprising each bid-offer pair of the plurality of bid-offer pairs that satisfies each of the following conditions:
(a) the bid price of the bid-offer pair and the offer price of the bid-offer pair are both unexpired at the time of interest;
(b) the bid price of the bid-offer pair is lower than the offer price of the bid-offer pair;
(c) the bid-offer pair comprises a quote spread that is less than a predetermined threshold;
(5) determining by the at least one processor from the set of qualifying bid-offer pairs a set of overlapping bid-offer pairs, in which each overlapping bid-offer pair comprises a range such that (i) the number of bid-offer pairs having a range that overlaps the range of the bid-offer pair is at least half of (ii) the number of eligible bid-offer pairs minus one, in which two ranges overlap if they both include at least one price in common;
determining by the at least one processor an exchange rate for converting the first currency into the second currency based on the set of overlapping bid-offer pairs, in which the act of determining the exchange rate comprises calculating an average of the bids and offers in the set of overlapping bid-offer pairs;
receiving by the at least one processor from the first user a first order to purchase the first currency in exchange for the second currency, in which the order to purchase is unexpired during the time of interest;
receiving by the at least one processor from the second user a second order to sell the first currency in exchange for the second currency, in which the order to sell is unexpired during the time of interest;
matching by the at least one processor the first order and the second order;
executing by the at least one processor a trade between the first user and the second user based on the act of matching; and
transmitting a confirmation of the executed trade to the first user and the second user.

10. The method of claim 1, in which each bid price and each offer price is associated with a corresponding time duration, and in which the act of determining that the bid price and the offer price of each bid-offer pair in the set of eligible bid-offer pairs is unexpired during the time of interest comprises:
determining, that the time of interest is within the time duration associated with each bid price and offer price.

11. The method of claim 1, in which the set of qualifying bid-offer pairs comprises a bid-offer pair from the first user and a bid-offer pair from the second user.

12. The method of claim 1, in which the order to purchase comprises a first quantity of units of the first currency, and the order to sell comprises a second quantity of units of the first currency.

13. The method of claim 1, in which the first order specifies a first quantity and the second order specifies a second quantity, in which the act of executing the trade comprises executing a trade between the first user and the second user an a volume equal to the lesser of the first quantity and the second quantity.

14. The method of claim 1, in which a submission of an order by a user is not revealed to any other user until after the order is executed.

15. The method of claim 1, in which the exchange rate is equal to the average of the bids and offers in the set of overlapping bid-offer pairs

16. The method of claim 1, in which the exchange rate is equal to a time-weighted average of the bids and offers in the set of overlapping bid-offer pairs, in which the bids and offers received at a time closer to the time of interest are weighted more heavily than the bids and offers received at a time further away from the time of interest.
